(19) United States
(12) Patent Application Publication
(10) Pub. No.: US 2019/0155082 A1
(43) Pub. Date: May 23, 2019

(54) LIQUID CRYSTAL DISPLAY PANEL AND LIQUID CRYSTAL DISPLAY DEVICE

(71) Applicant: SHARP KABUSHIKI KAISHA, Sakai City, Osaka (JP)

(72) Inventors: AKIRA SAKAI, Sakai City (JP); MASAHIRO HASEGAWA, Sakai City (JP); TAKAKO KOIDE, Sakai City (JP); KOZO NAKAMURA, Sakai City (JP); KIYOSHI MINOURA, Sakai City (JP); YUICHI KAWAHIRA, Sakai City (JP); KOJI MURATA, Sakai City (JP)

(21) Appl. No.: 16/093,358

(22) PCT Filed: Apr. 7, 2017
(86) PCT No.: PCT/JP2017/014432

§ 371 Date: Oct. 12, 2018

(30) Foreign Application Priority Data
Apr. 14, 2016 (JP) 2016-081340

(51) Int. Cl. G02F 1/13363; G02F 1/1343; G02F 1/1335

(52) U.S. Cl. CPC G02F 1/13363; G02F 1/134363; G02F 2001/133541; G02F 2001/133638; G02F 1/133528

(57) ABSTRACT

The liquid crystal display panel includes: a first polarizing plate; a first retardation provision portion including a first λ/4 plate; a first substrate; a second retardation provision portion including a second λ/4 plate; a liquid crystal layer containing nematic liquid crystal; a second substrate; and a second polarizing plate. One of the first substrate and the second substrate includes a pair of electrodes configured to generate a horizontal electric field at the liquid crystal layer upon voltage application. The nematic liquid crystal homogeneously aligns with no voltage application between the electrodes. One of the first retardation provision portion and the second retardation provision portion includes, on the first substrate side, a first retarder. The in-plane slow axis of the first λ/4 plate forms an angle of 45° with the absorption axis of the first polarizing plate and is orthogonal to the in-plane slow axis of the second λ/4 plate.

### TECHNICAL FIELD

The present invention relates to a liquid crystal display panel and a liquid crystal display device. The present invention more specifically relates to a horizontal electric field mode liquid crystal display panel and a liquid crystal display device including the liquid crystal display panel.

### BACKGROUND ART

Liquid crystal display panels have been used not only for televisions but also for smartphones, tablet PCs, car navigation systems, and the like. In these usages, various kinds of capabilities have been requested, and for example, horizontal electric field modes such as an in-plane switching (IPS) mode and a fringe field switching (FFS) mode have been disclosed (refer to Patent Literature 1 and Non-Patent Literature 1, for example).

### CITATION LIST

### Patent Literature

Patent Literature 1: JP 2012-173672 A

### Non-Patent Literature

Non-Patent Literature 1: Imayama et al., “Novel Pixel Design for a Transflective IPS-LCD with an In-Cell Retarder”, SID07 DIGEST, 2007, pp. 1651 to 1654

### SUMMARY OF INVENTION

### Technical Problem

However, the visibility of a conventional liquid crystal display panel decreases at a bright place such as an outdoor place in some cases (with reduced contrast and bleached appearance). Through various discussions, the inventors have found that luminance at black display substantially increases due to surface reflection and internal reflection of the liquid crystal display panel, and as a result, the contrast is reduced.

FIG. 44 is a schematic cross-sectional view for description of surface reflection and internal reflection of a conventional liquid crystal display panel. As illustrated in FIG. 44, a liquid crystal display panel 302 includes a first polarizing plate 304, a first substrate 308, a liquid crystal layer 311, a second substrate 312, and a second polarizing plate 313 sequentially from an observation surface side toward a back surface side.

Incident light a from the observation surface side (first polarizing plate 304 side) of the liquid crystal display panel 302 is mainly reflected as reflected light b1, reflected light b2, reflected light b3, and reflected light b4 at the surface of the liquid crystal display panel 302 and inside thereof. When an antireflection film is disposed on the observation surface side of the liquid crystal display panel 302, surface reflection (the reflected light b1) of the liquid crystal display panel 302 is reduced, but no effect is obtained for internal reflection (the reflected light b2, the reflected light b3, and the reflected light b4) of the liquid crystal display panel 302. The internal reflection of the liquid crystal display panel 302 is attributable to reflection from, for example, a black matrix, a color filter layer, an electrode (including an electrode disposed on the observation surface side of the first substrate 308, such as a transparent electrode for touch panel operation or electromagnetic wave shield), a metal conductive line, and an insulating film included in the first substrate 308 and the second substrate 312. In particular, in the internal reflection of the liquid crystal display panel 302, reflection (the reflected light b2 and the reflected light b3) from the first substrate 308 causes problems. However, reflection (the reflected light b4) from the second substrate 312 normally is smaller than reflection (the reflected light b2 and the reflected light b3) from the first substrate 308, and causes no problems in many cases. This is because, in such a case, a color filter layer is disposed on the first substrate 308, and thus the intensity of the incident light a is attenuated substantially to ¼ or smaller as the light passes through the color filter layer (first substrate 308) twice on a path through which the light is reflected as the reflected light b4 at the second substrate 312.

To reduce reflection (the reflected light b2 and the reflected light b3) from the first substrate 308, a circular polarizing plate (laminated body of a linear polarizing plate and a λ/4 plate) can be disposed on the observation surface side of the first substrate 308. For example, in a known configuration, a vertical alignment (VA) mode liquid crystal display panel includes a circular polarizing plate, but the VA mode liquid crystal display panel has a viewing angle narrower than those of liquid crystal display panels of horizontal electric field modes such as the IPS mode and the FFS mode, and thus does not have wide applications. The liquid crystal display panel of a horizontal electric field mode such as the IPS mode or the FFS mode has an excellent viewing angle characteristic, and is difficult to be provided with a circular polarizing plate. This is because, when circular polarizing plates are disposed on the observation surface side and back surface side of the horizontal electric field mode liquid crystal display panel, the liquid crystal display panel is constantly in a white (bright) display state with no voltage application or at voltage application, and it is unable to achieve a black (dark) display state.

Patent Literature 1 discloses provision of an IPS mode liquid crystal panel that can achieve an excellent image quality when used outdoor. However, the invention disclosed in Patent Literature 1 does not provide a sufficient viewing angle characteristic at a bright place, and needs to be improved.

Non-Patent Literature 1 discloses a transflective IPS mode liquid crystal display including a patterned in-cell retarder. However, a configuration disclosed in Non-Patent Literature 1 includes no in-cell retarder disposed at a transmissive part, and thus does not achieve transmissive display in the horizontal electric field mode by using a circular polarizing plate.

In view of the above state of the art, it is an object of the present invention to provide a horizontal electric field mode liquid crystal display panel having an excellent viewing angle characteristic at a bright place, and a liquid crystal display device including the liquid crystal display panel.

### Solution to Problem

The present inventors made various investigations concerning a horizontal electric field mode liquid crystal display panel having an excellent viewing angle characteristic at a bright place, and found a configuration that includes a circular polarizing plate on the observation surface side and thus is optically equivalent to that of a conventional horizontal electric field mode liquid crystal display panel for incident light. Then, the inventors found that a configuration in which a first retardation provision portion including a first λ/4 plate having principal refractive indexes satisfying a predetermined relation, and a first polarizing plate are sequentially disposed on a side (the observation surface side) of a first substrate opposite to a liquid crystal layer, the first substrate being a substrate on the observation surface side between paired substrates with the liquid crystal layer interposed therebetween, a second retardation provision portion including a second λ/4 plate having principal refractive indexes satisfying a predetermined relation is disposed on the liquid crystal layer side (back surface side), and one of the first retardation provision portion and the second retardation provision portion includes, on the first substrate side, a first retarder having principal refractive indexes satisfying a predetermined relation. These findings have now led to completion of the present invention capable of solving the above-described problem.

Specifically, an aspect of the present invention may be a liquid crystal display panel (hereinafter also referred to as a first liquid crystal display panel according to the present invention) including, sequentially from an observation surface side toward a back surface side: a first polarizing plate; a first retardation provision portion; a first substrate; a second retardation provision portion; a liquid crystal layer containing nematic liquid crystal; a second substrate; and a second polarizing plate. One of the first substrate and the second substrate includes a pair of electrodes configured to generate a horizontal electric field at the liquid crystal layer upon voltage application. The nematic liquid crystal homogeneously aligns with no voltage application between the electrodes. The first retardation provision portion includes a first λ/4 plate having principal refractive indexes satisfying the relation of nx>ny≥nz. The second retardation provision portion includes a second λ/4 plate having principal refractive indexes satisfying the relation of nx>ny≥nz. One of the first retardation provision portion and the second retardation provision portion includes, on the first substrate side, a first retarder having principal refractive indexes satisfying the relation of nx≤ny<nz. The in-plane slow axis of the first λ/4 plate forms an angle of 45° with the absorption axis of the first polarizing plate and is orthogonal to the in-plane slow axis of the second λ/4 plate.

Another aspect of the present invention may be a liquid crystal display panel (hereinafter also referred to as a second liquid crystal display panel according to the present invention) including, sequentially from an observation surface side toward a back surface side: a first polarizing plate; a first retardation provision portion; a first substrate; a second retardation provision portion; a liquid crystal layer containing nematic liquid crystal; a second substrate; and a second polarizing plate. One of the first substrate and the second substrate includes a pair of electrodes configured to generate a horizontal electric field at the liquid crystal layer upon voltage application. The nematic liquid crystal homogeneously aligns with no voltage application between the electrodes. The first retardation provision portion includes a first λ/4 plate having principal refractive indexes satisfying the relation of nx<ny≤nz. The second retardation provision portion includes a second λ/4 plate having principal refractive indexes satisfying the relation of nx<ny≤nz. One of the first retardation provision portion and the second retardation provision portion includes, on the first substrate side, a first retarder having principal refractive indexes satisfying the relation of nx≥ny>nz. The in-plane slow axis of the first λ/4 plate forms an angle of 45° with the absorption axis of the first polarizing plate and is orthogonal to the in-plane slow axis of the second λ/4 plate.

Another aspect of the present invention may be a liquid crystal display device including the liquid crystal display panel (the first liquid crystal display panel according to the present invention or the second liquid crystal display panel according to the present invention).

### Advantageous Effects of Invention

The present invention provides a horizontal electric field mode liquid crystal display panel having an excellent viewing angle characteristic at a bright place, and a liquid crystal display device including the liquid crystal display panel.

### BRIEF DESCRIPTION OF DRAWINGS

FIG. 1 is a schematic cross-sectional view illustrating a liquid crystal display device according to Embodiment 1-1.

FIG. 2 is a schematic cross-sectional view illustrating an exemplary configuration of a second substrate.

FIG. 3 is a schematic cross-sectional view illustrating a liquid crystal display device according to a modification of Embodiment 1-1.

FIG. 4 is a schematic cross-sectional view illustrating a liquid crystal display device according to Embodiment 1-2.

FIG. 5 is a schematic cross-sectional view illustrating a liquid crystal display device according to Embodiment 2-1.

FIG. 6 is a schematic cross-sectional view illustrating a liquid crystal display device according to Embodiment 2-2.

FIG. 7 is a schematic cross-sectional view illustrating a liquid crystal display panel according to Reference Example 1.

FIG. 8 is a schematic cross-sectional view illustrating a liquid crystal display panel according to Comparative Example 1.

FIG. 9 is a contour diagram illustrating a simulation result of the viewing angle characteristic of transmittance for a liquid crystal display panel according to Example 1.

FIG. 10 is a contour diagram illustrating a simulation result of the viewing angle characteristic of transmittance for a liquid crystal display panel according to Example 11.

FIG. 11 is a contour diagram illustrating a simulation result of the viewing angle characteristic of transmittance for the liquid crystal display panel according to Reference Example 1.

FIG. 12 is a contour diagram illustrating a simulation result of the viewing angle characteristic of transmittance for the liquid crystal display panel according to Comparative Example 1.

FIG. 13 is a graph illustrating a section taken at the polar angle of 60° in each of the contour diagrams illustrated in FIGS. 9 to 12.

FIG. 14 is a diagram obtained by projecting, onto the S₁-S₂ plane of a Poincare sphere, polarization states before and after transmission through each component of the liquid crystal display panel according to Example 1 when observed in a direction at the azimuth angle of 0° and the polar angle of 60°.

FIG. 15 is a diagram obtained by projecting, onto the S₁-S₂ plane of a Poincare sphere, polarization states before and after transmission through each component of the liquid crystal display panel according to Example 1 when observed in a direction at the azimuth angle of 45° and the polar angle of 60°.

FIG. 16 is a diagram obtained by projecting, onto the S₁-S₂ plane of a Poincare sphere, polarization states before and after transmission through each component of the liquid crystal display panel according to Example 11 when observed in a direction at the azimuth angle of 0° and the polar angle of 60°.

FIG. 17 is a diagram obtained by projecting, onto the S₁-S₂ plane of a Poincare sphere, polarization states before and after transmission through each component of the liquid crystal display panel according to Example 11 when observed in a direction at the azimuth angle of 45° and the polar angle of 60°.

FIG. 18 is a diagram obtained by projecting, onto the S₁-S₂ plane of a Poincare sphere, polarization states before and after transmission through each component of the liquid crystal display panel according to Comparative Example 1 when observed in a direction at the azimuth angle of 0° and the polar angle of 60°.

FIG. 19 is a diagram obtained by projecting, onto the S₁-S₂ plane of a Poincare sphere, polarization states before and after transmission through each component of the liquid crystal display panel according to Comparative Example 1 when observed in a direction at the azimuth angle of 45° and the polar angle of 60°.

FIG. 20 is a contour diagram illustrating a simulation result of the viewing angle characteristic of transmittance for a liquid crystal display panel according to Example 2.

FIG. 21 is a contour diagram illustrating a simulation result of the viewing angle characteristic of transmittance for a liquid crystal display panel according to Example 3.

FIG. 22 is a graph illustrating the relation between a thickness direction retardation of a first retarder and transmittance when a first λ/4 plate and a second λ/4 plate are uniaxial λ/4 plates (nx>ny=nz, and Nz=1.0).

FIG. 23 is a contour diagram illustrating a simulation result of the viewing angle characteristic of transmittance for a liquid crystal display panel according to Example 4.

FIG. 24 is an xy chromaticity diagram derived from a transmittance calculation result for the liquid crystal display panel according to Example 1.

FIG. 25 is a contour diagram illustrating an image of the coloring state of the liquid crystal display panel according to Example 1.

FIG. 26 is an xy chromaticity diagram derived from a transmittance calculation result for the liquid crystal display panel according to Example 4.

FIG. 27 is a contour diagram illustrating an image of the coloring state of the liquid crystal display panel according to Example 4.

FIG. 28 is a contour diagram illustrating a simulation result of the viewing angle characteristic of transmittance for a liquid crystal display panel according to Example 5.

FIG. 29 is a graph illustrating the relation between the thickness direction retardation of the first retarder and transmittance when the first λ/4 plate is a biaxial λ/4 plate (nx>ny>nz, and Nz=1.5) and the second λ/4 plate is a uniaxial λ/4 plate (nx>ny=nz, and Nz=1.0).

FIG. 30 is a contour diagram illustrating a simulation result of the viewing angle characteristic of transmittance for a liquid crystal display panel according to Example 6.

FIG. 31 is a graph illustrating the relation between the thickness direction retardation of the first retarder and transmittance when the first λ/4 plate is a biaxial λ/4 plate (nx>ny>nz, and Nz=2.0) and the second λ/4 plate is a uniaxial λ/4 plate (nx>ny=nz, and Nz=1.0).

FIG. 32 is a graph illustrating the relation between the Nz coefficient of the first λ/4 plate and an optimum value of the thickness direction retardation of the first retarder when focus is on the symmetric property of the viewing angle characteristic, which is derived from FIGS. 22, 29, and 31.

FIG. 33 is a contour diagram illustrating a simulation result of the viewing angle characteristic of transmittance for a liquid crystal display panel according to Example 7.

FIG. 34 is a contour diagram illustrating a simulation result of the viewing angle characteristic of transmittance for a liquid crystal display panel according to Example 8.

FIG. 35 is a graph illustrating the relation between the thickness direction retardation of the first retarder and transmittance when the first λ/4 plate is a uniaxial λ/4 plate (nx>ny=nz, and Nz=1.0) and the second λ/4 plate is a biaxial λ/4 plate (nx>ny>nz, and Nz=1.5).

FIG. 36 is a contour diagram illustrating a simulation result of the viewing angle characteristic of transmittance for a liquid crystal display panel according to Example 9.

FIG. 37 is a contour diagram illustrating a simulation result of the viewing angle characteristic of transmittance for a liquid crystal display panel according to Example 10.

FIG. 38 is a graph illustrating the relation between the thickness direction retardation of the first retarder and transmittance when the first λ/4 plate and the second λ/4 plate are biaxial λ/4 plates (nx>ny>nz, and Nz=1.5).

FIG. 39 is a contour diagram illustrating a simulation result of the viewing angle characteristic of transmittance for a liquid crystal display panel according to Example 12.

FIG. 40 is a contour diagram illustrating a simulation result of the viewing angle characteristic of transmittance for a liquid crystal display panel according to Example 13.

FIG. 41 is a contour diagram illustrating a simulation result of the viewing angle characteristic of transmittance for a liquid crystal display panel according to Example 14.

FIG. 42 is a contour diagram illustrating a simulation result of the viewing angle characteristic of transmittance for a liquid crystal display panel according to Comparative Example 2.

FIG. 43 is a graph illustrating the relation between the thickness direction retardation of the first retarder and transmittance when the first λ/4 plate and the second λ/4 plate are uniaxial λ/4 plates (nx<ny=nz, and Nz=0).

FIG. 44 is a schematic cross-sectional view for description of surface reflection and internal reflection of a conventional liquid crystal display panel.

### DESCRIPTION OF EMBODIMENTS

Embodiments of the present invention will be described further in detail below with reference to the accompanying drawings, but the present invention is not limited to these embodiments. Configurations of the embodiments may be combined or changed as appropriate without departing from the scope of the present invention.

In the present specification, a “polarizing plate” without “linear” means a linear polarizing plate and is distinguished from a circular polarizing plate.

In the present specification, a λ/4 plate means a retarder that provides an in-plane retardation of ¼ wavelength (137.5 nm, precisely) to at least light having a wavelength of 550 nm, and includes a retarder that provides an in-plane retardation of 100 nm or more and 176 nm or less. Light having a wavelength of 550 nm is light of a wavelength at which a human has highest visual sensitivity.

In the present specification, nx and ny represent the principal refractive indexes of a retarder (including a λ/4 plate) in in-plane directions, and nz represents the principal refractive index of the retarder in the thickness direction. Each principal refractive index is a value for light having a wavelength of 550 nm unless otherwise stated. When the larger one of nx and ny is represented by ns and the smaller one is represented by nf, an in-plane slow axis is an axis in a direction corresponding to ns, and an in-plane fast axis is an axis in a direction corresponding to nf.

In the present specification, an in-plane retardation (R) is defined to be R=(ns−nf)×D. A thickness direction retardation (Rth) is defined to be Rth=(nz−(nx+ny)/2)×D. In the above expressions, D represents the thickness of a retarder (including a λ/4 plate).

In the present specification, an Nz coefficient is a parameter indicating the degree of biaxiality and defined to be Nz=(ns−nz)/(ns−nf). The Nz coefficient takes the following values, for example.

(1) When the principal refractive indexes satisfy the relation of nx>ny=nz (exhibit uniaxiality), ns=nx, and nf=ny, and thus Nz=1.

(2) When the principal refractive indexes satisfy the relation of nx>ny>nz (exhibit biaxiality), Nz>1.

(3) When the principal refractive indexes satisfy the relation of nx<ny=nz (exhibit uniaxiality), ns=ny, and nf=nx, and thus Nz=0.

(4) When the principal refractive indexes satisfy the relation of nx<ny<nz (exhibit biaxiality), Nz<0.

(5) When the principal refractive indexes satisfy the relation of nx=ny<nz (exhibit uniaxiality), ns−nf=0, and thus Nz is not defined.

(6) When the principal refractive indexes satisfy the relation of nx=ny>nz (exhibit uniaxiality), ns−nf=0, and thus Nz is not defined.

In the present specification, the retardation of a liquid crystal layer means the maximum value of an effective retardation provided by the liquid crystal layer, and is defined to be Δn×d where Δn and d represent the refractive index anisotropy and thickness of the liquid crystal layer, respectively. The retardation of the liquid crystal layer is a value for light having a wavelength of 550 nm unless otherwise stated.

In the present specification, when two axes (directions) are orthogonal to each other, the angle (absolute value) between the axes is in the range of 90±3°, preferably in the range of 90±1°, more preferably in the range of 90±0.50, particularly preferably equal to 90° (completely orthogonal to each other). When two axes (directions) are parallel to each other, the angle (absolute value) between the axes is in the range of 0±30, preferably in the range of 0±1°, more preferably in the range of 0±0.5°, particularly preferably equal to 0° (completely parallel to each other). When two axes (directions) form an angle of 45°, the angle (absolute value) between the axes is in the range of 45±30, preferably in the range of 45±1°, more preferably in the range of 45±0.5°, particularly preferably equal to 45° (perfect 45°).

### Embodiment 1-1

Embodiment 1-1 relates to the above-described first liquid crystal display panel according to the present invention, and the above-described liquid crystal display device including the first liquid crystal display panel according to the present invention.

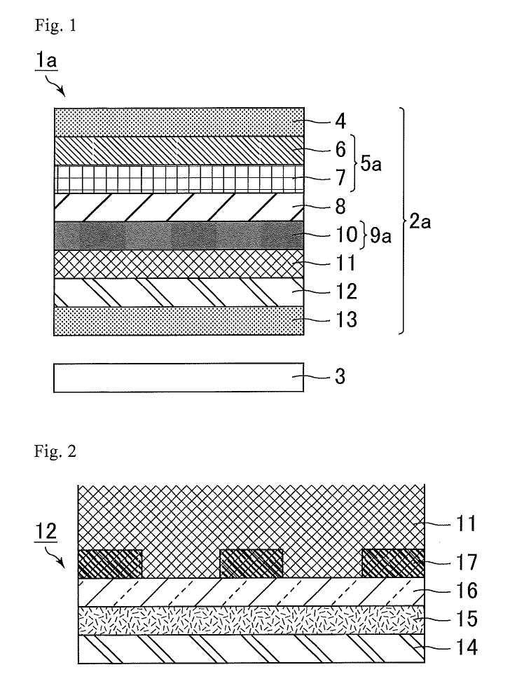

FIG. 1 is a schematic cross-sectional view illustrating a liquid crystal display device according to Embodiment 1-1. As illustrated in FIG. 1, this liquid crystal display device 1a includes a liquid crystal display panel 2a and a backlight 3 sequentially from an observation surface side toward a back surface side.

The type of the backlight 3 is not limited, and an edge-lit type or direct-lit type backlight may be employed, for example. The type of a light source of the backlight 3 is not limited, but may be, for example, a light-emitting diode (LED) or a cold cathode fluorescent lamp (CCFL).

The liquid crystal display panel 2a includes a first polarizing plate 4, a first retardation provision portion 5a, a first substrate 8, a second retardation provision portion 9a, a liquid crystal layer 11, a second substrate 12, and a second polarizing plate 13 sequentially from the observation surface side toward the back surface side.

The first polarizing plate 4 and the second polarizing plate 13 may be each, for example, a polarizer (absorption polarizing plate) obtained by causing an anisotropic material such as iodine complex (or dye) to dye and adsorb on a polyvinyl alcohol (PVA) film and then stretching and aligning the film.

The first polarizing plate 4 and the second polarizing plate 13 preferably have transmission axes orthogonal to each other. With this configuration, the first polarizing plate 4 and the second polarizing plate 13 are disposed in crossed Nicols, and thus a preferable black display state can be achieved with no voltage application.

One of the first substrate 8 and the second substrate 12 includes a pair of electrodes configured to generate a horizontal electric field at the liquid crystal layer 11 upon voltage application. The following exemplarily describes a case in which the second substrate 12 is an FFS mode thin-film transistor array substrate with reference to FIG. 2.

FIG. 2 is a schematic cross-sectional view illustrating an exemplary configuration of the second substrate. As illustrated in FIG. 2, the second substrate 12 includes a support substrate 14, a common electrode (planar electrode) 15 disposed on a surface of the support substrate 14 on the liquid crystal layer 11 side, an insulating film 16 covering the common electrode 15, and a pixel electrode (comb teeth electrode) 17 disposed on a surface of the insulating film 16 on the liquid crystal layer 11 side. With this configuration, when voltage is applied to the common electrode 15 and the pixel electrode 17 (at voltage application), a horizontal electric field (fringe electric field) is generated at the liquid crystal layer 11 so that alignment of liquid crystal molecules in the liquid crystal layer 11 can be controlled.

The support substrate 14 is, for example, a glass substrate or a plastic substrate.

The materials of the common electrode 15 and the pixel electrode 17 are each, for example, indium tin oxide (ITO) or indium zinc oxide (IZO).

The insulating film 16 is, for example, an organic insulating film or a nitride film.

In the second substrate 12, an alignment film may be disposed to cover the pixel electrode 17. The alignment film may be formed by a conventionally well-known method.

The case in which the second substrate 12 is an FFS mode thin-film transistor array substrate is exemplarily described above. In an IPS mode thin-film transistor array substrate in the same horizontal electric field mode, when voltage is applied to a pair of comb teeth electrodes (at voltage application), a horizontal electric field is generated at the liquid crystal layer 11 so that alignment of the liquid crystal molecules in the liquid crystal layer 11 can be controlled.

When the second substrate 12 is a thin-film transistor array substrate as described above, the first substrate 8 may be a color filter substrate. The color filter substrate may have a configuration in which, for example, a color filter layer is disposed on a support substrate (such as a glass substrate or a plastic substrate). The color filter layer is not limited to a particular color combination, but may have, for example, a combination of red, green, and blue, or a combination of red, green, blue, and yellow.

The liquid crystal layer 11 contains nematic liquid crystal. The nematic liquid crystal in the liquid crystal layer 11 homogeneously aligns with no voltage application between the electrodes included in one of the first substrate 8 and the second substrate 12 (with no voltage application).

The first retardation provision portion 5a includes a first λ/4 plate 6 and a first retarder 7 sequentially from the first polarizing plate 4 side toward the first substrate 8 side.

The first λ/4 plate 6 is a λ/4 plate having principal refractive indexes satisfying the relation of nx>ny≥nz. The first λ/4 plate 6 includes, by definition, a uniaxial λ/4 plate (positive A plate) having principal refractive indexes satisfying the relation of nx>ny=nz and a biaxial λ/4 plate having principal refractive indexes satisfying the relation of nx>ny>nz.

The first retarder 7 is a retarder having principal refractive indexes satisfying the relation of nx S ny<nz. The first retarder 7 includes, by definition, a uniaxial retarder (positive C plate) having principal refractive indexes satisfying the relation of nx=ny<nz and a biaxial retarder having principal refractive indexes satisfying the relation of nx<ny<nz.

The second retardation provision portion 9a includes a second λ/4 plate 10.

The second λ/4 plate 10 is a λ/4 plate having principal refractive indexes satisfying the relation of nx>ny≥nz. The second λ/4 plate 10 includes, by definition, a uniaxial λ/4 plate (positive A plate) having principal refractive indexes satisfying the relation of nx>ny=nz and a biaxial λ/4 plate having principal refractive indexes satisfying the relation of nx>ny>nz.

An alignment film may be disposed on a surface of the second λ/4 plate 10 on the liquid crystal layer 11 side.

The first λ/4 plate 6, the second λ/4 plate 10, and the first retarder 7 may be each obtained by, for example, stretching a polymer film. The polymer film is stretched by, for example, a method of holding a polymer film in a roll shape with a stretching clip and stretching the film. Such a stretching method that performs the stretching in a parallel direction to the flow direction of the polymer film is called a longitudinal stretching method. A method that performs the stretching in a direction not parallel to the flow direction of the polymer film is called, for example, a transverse stretching method or an oblique stretching method. For example, when the polymer film is stretched by the oblique stretching method, free contraction of the polymer film in a direction orthogonal to the stretching direction is encumbered, and the polymer film becomes what is called a fixed end stretched state and substantially exhibits biaxiality in some cases. This can be expressed in the principal refractive index relation of nx>ny>nz for the first λ/4 plate 6 and the second λ/4 plate 10, and in the principal refractive index relation of nx<ny<nz for the first retarder 7.

The second λ/4 plate 10 can be produced as follows. First, a multilayer film is formed by sequentially applying an alignment film for the second λ/4 plate 10 and a liquid-crystalline photopolymerization material (photopolymerizable monomer exhibiting liquid crystallinity) on a surface of the first substrate 8 on the liquid crystal layer 11 side. Thereafter, baking and ultraviolet irradiation are sequentially performed on the multilayer film so that the liquid-crystalline photopolymerization material functions as the second λ/4 plate 10. Similarly, the first λ/4 plate 6 can be formed on a substrate by using the above-described materials and method and bonded to the first polarizing plate 4.

The in-plane slow axis of the first λ/4 plate 6 and the absorption axis of the first polarizing plate 4 form an angle of 45°. With this configuration, a circular polarizing plate in which the first polarizing plate 4 and the first λ/4 plate 6 are stacked is disposed on the observation surface side of the liquid crystal display panel 2a. Accordingly, when transmitting through the circular polarizing plate, incident light from the observation surface side (the first polarizing plate 4 side) of the liquid crystal display panel 2a is converted into circularly polarized light before reaching the first substrate 8, and thus reflection from the first substrate 8 is reduced by the effect of reflection prevention by the circular polarizing plate. When the first polarizing plate 4 and the first λ/4 plate 6 are stacked to form the circular polarizing plate, a roll-to-roll scheme is preferably employed to increase manufacturing efficiency.

The in-plane slow axis of the first λ/4 plate 6 and the in-plane slow axis of the second λ/4 plate 10 are orthogonal to each other. With this configuration, the first λ/4 plate 6 and the second λ/4 plate 10 can cancel retardations thereof for light incident at least in a direction normal to the liquid crystal display panel 2a, thereby achieving an optical state in which both plates substantially do not exist. In other words, a configuration optically equivalent to that of a conventional horizontal electric field mode liquid crystal display panel is achieved for light incident on the liquid crystal display panel 2a from the backlight 3 (light incident at least in the direction normal to the liquid crystal display panel 2a). Thus, display can be achieved in the horizontal electric field mode using the circular polarizing plate. The first λ/4 plate 6 and the second ¼ plate 10 are preferably made of an identical material. Accordingly, the first λ/4 plate 6 and the second λ/4 plate 10 can cancel retardations thereof including wavelength dispersion.

To achieve a viewing angle characteristic equivalent to that of a conventional horizontal electric field mode liquid crystal display panel, a configuration optically equivalent to that of a conventional horizontal electric field mode liquid crystal display panel is required not only for light incident in the direction normal to the liquid crystal display panel 2a but also for light incident in a direction oblique thereto. More precisely, the polarization state of light right before incidence on the first polarizing plate 4 is required to be substantially the same as the polarization state of light right after transmission through the liquid crystal layer 11. In the present embodiment, the first retarder 7 is disposed between the first λ/4 plate 6 and the second λ/4 plate 10 to achieve optimization (optical compensation) of change of the polarization state in an oblique direction. For example, when the first retarder 7 has principal refractive indexes satisfying the relation of nx=ny<nz, in other words, the first retarder 7 is a positive C plate, a retardation through the first retarder 7 in the normal direction thereof is zero, and thus optical performance of the liquid crystal display panel 2a in the normal direction is not affected by the existence of the first retarder 7.

According to Embodiment 1-1, an excellent viewing angle characteristic at a bright place is obtained by the following effects.

(1) Since the circular polarizing plate in which the first polarizing plate 4 and the first λ/4 plate 6 are stacked is disposed on the observation surface side of the liquid crystal display panel 2a, increased visibility at a bright place is achieved by the effect of reflection prevention by the circular polarizing plate.

(2) Since the first retarder 7 is disposed between the first λ/4 plate 6 and the second λ/4 plate 10, a configuration optically equivalent to that of a conventional horizontal electric field mode liquid crystal display panel can be achieved not only for light incident in the direction normal to the liquid crystal display panel 2a but also for light incident in a direction oblique thereto.

### [Modification of Embodiment 1-1]

A modification of Embodiment 1-1 is the same as Embodiment 1-1 except that a second retarder is added to the first retardation provision portion, and thus any duplicate description thereof will be omitted as appropriate.

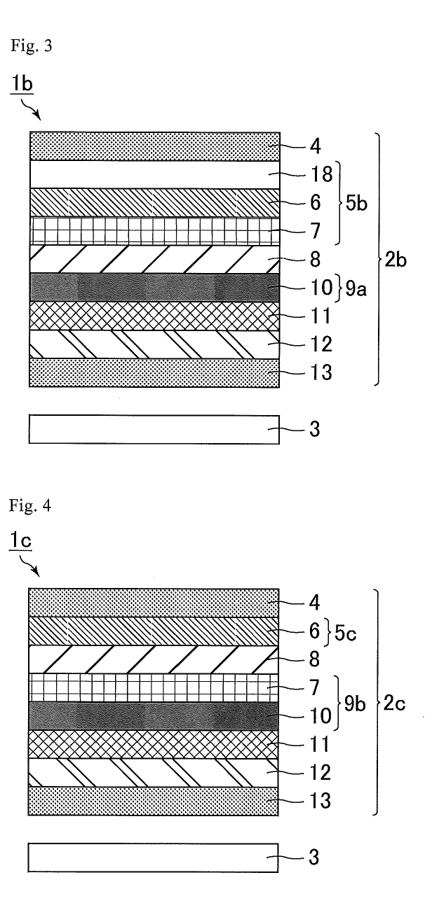

FIG. 3 is a schematic cross-sectional view illustrating a liquid crystal display device according to the modification of Embodiment 1-1. As illustrated in FIG. 3, this liquid crystal display device 1b includes a liquid crystal display panel 2b and the backlight 3 sequentially from the observation surface side toward the back surface side.

The liquid crystal display panel 2b includes the first polarizing plate 4, a first retardation provision portion 5b, the first substrate 8, the second retardation provision portion 9a, the liquid crystal layer 11, the second substrate 12, and the second polarizing plate 13 sequentially from the observation surface side toward the back surface side.

The first retardation provision portion 5b includes a second retarder 18, the first λ/4 plate 6, and the first retarder 7 sequentially from the first polarizing plate 4 side toward the first substrate 8 side.

The second retarder 18 is a uniaxial retarder (negative A plate) having principal refractive indexes satisfying the relation of nx<ny=nz. The second retarder 18 may be the same as, for example, the above-described first retarder 7 (the first λ/4 plate 6 and the second λ/4 plate 10) except for the different principal refractive index relation.

The second retarder 18 preferably has an in-plane retardation of 100 nm or more and 176 nm or less, particularly preferably has an in-plane retardation of 137 nm.

According to the modification of Embodiment 1-1, since the second retarder 18 (negative A plate) is disposed, viewing angle correction is performed for the first polarizing plate 4 and the second polarizing plate 13. Thus, the modification of Embodiment 1-1 can achieve a viewing angle wider than that of Embodiment 1-1.

### Embodiment 1-2

Embodiment 1-2 is the same as Embodiment 1-1 except that the first retardation provision portion and the second retardation provision portion have configurations different from those of Embodiment 1-1, and thus any duplicate description thereof will be omitted as appropriate.

FIG. 4 is a schematic cross-sectional view illustrating a liquid crystal display device according to Embodiment 1-2. As illustrated in FIG. 4, this liquid crystal display device 1c includes a liquid crystal display panel 2c and the backlight 3 sequentially from the observation surface side toward the back surface side.

The liquid crystal display panel 2c includes the first polarizing plate 4, a first retardation provision portion 5c, the first substrate 8, a second retardation provision portion 9b, the liquid crystal layer 11, the second substrate 12, and the second polarizing plate 13 sequentially from the observation surface side toward the back surface side.

The first retardation provision portion 5c includes the first λ/4 plate 6.

The second retardation provision portion 9b includes the second λ/4 plate 10 and the first retarder 7 sequentially from the liquid crystal layer 11 side toward the first substrate 8 side.

According to Embodiment 1-2, the same effects as those of Embodiment 1-1 can be achieved.

Optimum one of Embodiments 1-1 and 1-2 may be selected as appropriate to achieve manufacturing efficiency (such as cost and quality). For example, Embodiment 1-2 is preferably selected when there is a circular polarizing plate (laminated body of the first polarizing plate 4 and the first λ/4 plate 6) to be used in common with another product to increase mass production effect (simultaneously achieve cost and quality). When Embodiment 1-2 is selected, a circular polarizing plate including the first retarder 7 does not need to be newly produced, but a circular polarizing plate common to the other product can be used.

However, Embodiment 1-1 is preferably selected when mass production effect can be more easily increased (cost and quality can be more easily simultaneously achieved) by newly producing a circular polarizing plate including the first retarder 7.

### Embodiment 2-1

Embodiment 2-1 relates to the second liquid crystal display panel according to the present invention described above, and a liquid crystal display device including the second liquid crystal display panel according to the present invention described above. Embodiment 2-1 is the same as Embodiment 1-1 except that the first λ/4 plate, the second λ/4 plate, and the first retarder have different principal refractive index relations, and thus any duplicate description thereof will be omitted as appropriate.

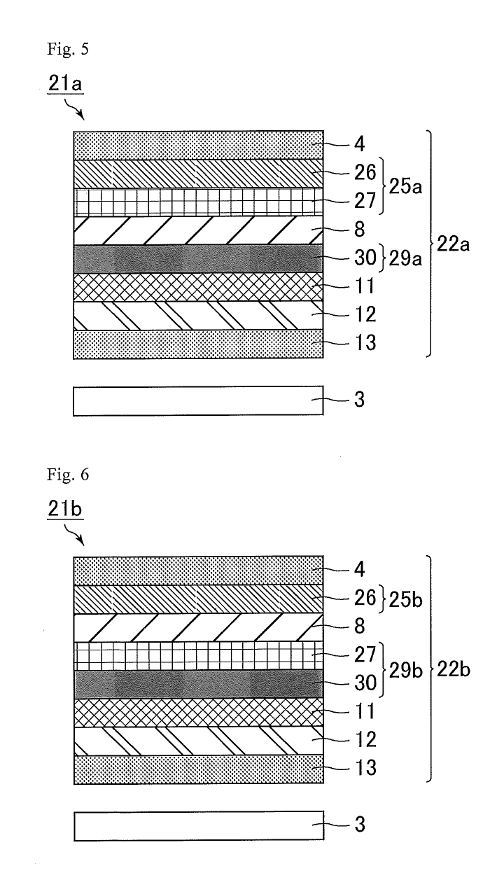

FIG. 5 is a schematic cross-sectional view illustrating a liquid crystal display device according to Embodiment 2-1. As illustrated in FIG. 5, this liquid crystal display device 21a includes a liquid crystal display panel 22a and the backlight 3 sequentially from the observation surface side toward the back surface side.

The liquid crystal display panel 22a includes the first polarizing plate 4, a first retardation provision portion 25a, the first substrate 8, a second retardation provision portion 29a, the liquid crystal layer 11, the second substrate 12, and the second polarizing plate 13 sequentially from the observation surface side toward the back surface side.

The first retardation provision portion 25a includes a first λ/4 plate 26 and a first retarder 27 sequentially from the first polarizing plate 4 side toward the first substrate 8 side.

The first λ/4 plate 26 is a λ/4 plate having principal refractive indexes satisfying the relation of nx<ny≤nz. The first λ/4 plate 26 includes, by definition, a uniaxial λ/4 plate (negative A plate) having principal refractive indexes satisfying the relation of nx<ny=nz and a biaxial λ/4 plate having principal refractive indexes satisfying the relation of nx<ny<nz.

The first retarder 27 is a retarder having principal refractive indexes satisfying the relation of nx≥ny>nz. The first retarder 27 includes, by definition, a uniaxial retarder (negative C plate) having principal refractive indexes satisfying the relation of nx=ny>nz and a biaxial retarder having principal refractive indexes satisfying the relation of nx>ny>nz.

The second retardation provision portion 29a includes a second λ/4 plate 30.

The second λ/4 plate 30 is a λ/4 plate having principal refractive indexes satisfying the relation of nx<ny≥nz. The second λ/4 plate 30 includes, by definition, a uniaxial λ/4 plate (negative A plate) having principal refractive indexes satisfying the relation of nx<ny=nz and a biaxial λ/4 plate having principal refractive indexes satisfying the relation of nx<ny<nz.

An alignment film may be disposed on a surface of the second λ/4 plate 30 on the liquid crystal layer 11 side.

The first λ/4 plate 26, the second λ/4 plate 30, and the first retarder 27 may be the same as, for example, the first λ/4 plate 6, the second λ/4 plate 10, and the first retarder 7 described above except for the different principal refractive index relations.

The in-plane slow axis of the first λ/4 plate 26 and the absorption axis of the first polarizing plate 4 form an angle of 45°. With this configuration, a circular polarizing plate in which the first polarizing plate 4 and the first λ/4 plate 26 are stacked is disposed on the observation surface side of the liquid crystal display panel 22a. Accordingly, when transmitting through the circular polarizing plate, incident light from the observation surface side (first polarizing plate 4 side) of the liquid crystal display panel 22a is converted into circularly polarized light before reaching the first substrate 8, and thus reflection from the first substrate 8 is reduced by the effect of reflection prevention by the circular polarizing plate. When the first polarizing plate 4 and the first λ/4 plate 26 are stacked to form the circular polarizing plate, a roll-to-roll scheme is preferably used to increase manufacturing efficiency.

The in-plane slow axis of the first λ/4 plate 26 and the in-plane slow axis of the second λ/4 plate 30 are orthogonal to each other. With this configuration, the first λ/4 plate 26 and the second λ/4 plate 30 can cancel retardations thereof for light incident at least in a direction normal to the liquid crystal display panel 22a, thereby achieving an optical state in which both plates substantially do not exist. In other words, a configuration optically equivalent to that of a conventional horizontal electric field mode liquid crystal display panel is achieved for light incident on the liquid crystal display panel 22a from the backlight 3 (light incident at least in a direction normal to the liquid crystal display panel 22a). Thus, display can be achieved in the horizontal electric field mode using the circular polarizing plate. The first λ/4 plate 26 and the second λ/4 plate 30 are preferably made of an identical material. Accordingly, the first λ/4 plate 26 and the second λ/4 plate 30 can cancel retardations thereof including wavelength dispersion.

To achieve a viewing angle characteristic equivalent to that of a conventional horizontal electric field mode liquid crystal display panel, a configuration optically equivalent to that of a conventional horizontal electric field mode liquid crystal display panel is required not only for light incident in a direction normal to the liquid crystal display panel 22a, but also for light incident in a direction oblique thereto. More precisely, the polarization state of light right before incidence on the first polarizing plate 4 is required to be substantially the same as the polarization state of light right after transmission through the liquid crystal layer 11. In the present embodiment, the first retarder 27 is disposed between the first λ/4 plate 26 and the second λ/4 plate 30 to achieve optimization (optical compensation) of change of the polarization state in an oblique direction. For example, when the first retarder 27 has principal refractive indexes satisfying the relation of nx=ny>nz, in other words, the first retarder 27 is a negative C plate, a retardation through the first retarder 27 in the normal direction thereof is zero, and thus optical performance of the liquid crystal display panel 22a in the normal direction is not affected by the existence of the first retarder 27.

According to Embodiment 2-1, an excellent viewing angle characteristic at a bright place is obtained by the following effects.

(1) Since the circular polarizing plate in which the first polarizing plate 4 and the first λ/4 plate 26 are stacked is disposed on the observation surface side of the liquid crystal display panel 22a, increased visibility at a bright place is achieved by the effect of reflection prevention by the circular polarizing plate.

(2) Since the first retarder 27 is disposed between the first λ/4 plate 26 and the second λ/4 plate 30, a configuration optically equivalent to that of a conventional horizontal electric field mode liquid crystal display panel can be achieved not only for light incident in a direction normal to the liquid crystal display panel 22a, but also for light incident in a direction oblique thereto.

### Embodiment 2-2

Embodiment 2-2 is the same as Embodiment 2-1 except that the first retardation provision portion and the second retardation provision portion have configurations different from those of Embodiment 2-1, and thus any duplicate description thereof will be omitted as appropriate.

FIG. 6 is a schematic cross-sectional view illustrating a liquid crystal display device according to Embodiment 2-2. As illustrated in FIG. 6, this liquid crystal display device 21b includes a liquid crystal display panel 22b and the backlight 3 sequentially from the observation surface side toward the back surface side.

The liquid crystal display panel 22b includes the first polarizing plate 4, a first retardation provision portion 25b, the first substrate 8, a second retardation provision portion 29b, the liquid crystal layer 11, the second substrate 12, and the second polarizing plate 13 sequentially from the observation surface side toward the back surface side.

The first retardation provision portion 25b includes the first λ/4 plate 26.

The second retardation provision portion 29b includes the second λ/4 plate 30 and the first retarder 27 sequentially from the liquid crystal layer 11 side toward the first substrate 8 side.

According to Embodiment 2-2, the same effects as those of Embodiment 2-1 can be achieved.

Optimum one of Embodiments 2-1 and 2-2 may be selected as appropriate to achieve manufacturing efficiency (such as cost and quality). For example, Embodiment 2-2 is preferably selected when there is the circular polarizing plate (laminated body of the first polarizing plate 4 and the first λ/4 plate 26) to be used in common with another product to increase mass production effect (simultaneously achieve cost and quality). When Embodiment 2-2 is selected, a circular polarizing plate including the first retarder 27 does not need to be newly produced, but a circular polarizing plate common to the other product can be used. However, Embodiment 2-1 is preferably selected when mass production effect can be more easily increased (cost and quality can be more easily simultaneously achieved) by newly producing a circular polarizing plate including the first retarder 27.

The viewing angle characteristic of transmittance of a liquid crystal display panel will be described below based on simulation results with reference to examples, reference examples, and comparative examples. The present invention is not limited to these examples.

In each example, a measurement wavelength for principal refractive indexes and retardations was set to be 550 nm. The azimuths of an absorption axis, a transmission axis, and an in-plane slow axis, and an alignment direction are defined to be positive (+) in an anticlockwise manner relative to the longitudinal direction (long side) of a liquid crystal display panel (simulation sample) (at 0°).

### Example 1

A liquid crystal display panel according to Example 1 (simulation sample) was the liquid crystal display panel according to Embodiment 1-1 including components as follows.

### <First Polarizing Plate 4>

Absorption polarizing plate

Azimuth of absorption axis: 0°

Azimuth of transmission axis: 90°

### <First λ/4 Plate 6>

Uniaxial λ/4 plate (positive A plate) (nx>ny=nz, and Nz=1.0)

In-plane retardation: 137.5 nm

Azimuth of in-plane slow axis: 45°

### <First Retarder 7>

Positive C plate (nx=ny<nz)

Thickness direction retardation: 87.5 nm

### <First Substrate 8>

Color filter substrate

### <Second λ/4 Plate 10>

Uniaxial λ/4 plate (positive A plate) (nx>ny=nz, and Nz=1.0)

In-plane retardation: 137.5 nm

Azimuth of in-plane slow axis: −45°

### <Liquid Crystal Layer 11>

Nematic liquid crystal

Retardation: 340 nm

Alignment direction (with no voltage application): 90°

### <Second Substrate 12>

FFS mode thin-film transistor array substrate

### <Second Polarizing Plate 13>

Absorption polarizing plate

Azimuth of absorption axis: 90°

Azimuth of transmission axis: 0°

### Example 2

The same simulation sample as that of Example 1 was employed except that the first retarder 7 had a different thickness direction retardation of 62.5 nm.

### Example 3

The same simulation sample as that of Example 1 was employed except that the first retarder 7 had a different thickness direction retardation of 112.5 nm.

### Example 4

The same simulation sample as that of Example 1 was employed except that the nematic liquid crystal in the liquid crystal layer 11 had a different alignment direction of 0° (with no voltage application).

### Example 5

The same simulation sample as that of Example 1 was employed except that the first λ/4 plate 6 and the first retarder 7 were changed as described below.

### <First λ/4 Plate 6>

Biaxial λ/4 plate (nx>ny>nz, and Nz=1.5)

In-plane retardation: 137.5 nm

Azimuth of in-plane slow axis: 45°

### <First Retarder 7>

Positive C plate (nx=ny<nz)

Thickness direction retardation: 127.5 nm

### Example 6

The same simulation sample as that of Example 1 was employed except that the first λ/4 plate 6 and the first retarder 7 were changed as described below.

### <First λ/4 Plate 6>

Biaxial λ/4 plate (nx>ny>nz, and Nz=2.0)

In-plane retardation: 137.5 nm

Azimuth of in-plane slow axis: 45°

### <First Retarder 7>

Positive C plate (nx=ny<nz)

Thickness direction retardation: 165 nm

### Example 7

The same simulation sample as that of Example 1 was employed except that the first retarder 7 and the second λ/4 plate 10 were changed as described below.

### <First Retarder 7>

Positive C plate (nx=ny<nz)

Thickness direction retardation: 140 nm

### <Second λ/4 Plate 10>

Biaxial λ/4 plate (nx>ny>nz, and Nz=1.5)

In-plane retardation: 137.5 nm

Azimuth of in-plane slow axis: −45°

### Example 8

The same simulation sample as that of Example 7 was employed except that the first retarder 7 had a different thickness direction retardation of 170 nm.

### Example 9

The same simulation sample as that of Example 1 was employed except that the first λ/4 plate 6, the first retarder 7 and the second λ/4 plate 10 were changed as described below.

### <First λ/4 Plate 6>

Biaxial λ/4 plate (nx>ny>nz, and Nz=1.5)

In-plane retardation: 137.5 nm

Azimuth of in-plane slow axis: 45°

### <First Retarder 7>

Positive C plate (nx=ny<nz)

Thickness direction retardation: 180 nm

### <Second λ/4 Plate 10>

Biaxial λ/4 plate (nx>ny>nz, and Nz=1.5)

In-plane retardation: 137.5 nm

Azimuth of in-plane slow axis: −45°

### Example 10

The same simulation sample as that of Example 9 was employed except that the first retarder 7 had a different thickness direction retardation of 230 nm.

### Example 11

A liquid crystal display panel according to Example 11 (simulation sample) was the liquid crystal display panel according to the modification of Embodiment 1-1. Any component other than the second retarder 18 was the same as that of Example 1.

### <Second Retarder 18>

Negative A plate (nx<ny=nz)

In-plane retardation: 137 nm

Azimuth of in-plane slow axis: 90°

### Example 12

A liquid crystal display panel according to Example 12 (simulation sample) was the liquid crystal display panel according to Embodiment 2-1 including components as follows.

### <First Polarizing Plate 4>

Absorption polarizing plate

Azimuth of absorption axis: 0°

Azimuth of transmission axis: 90°

### <First λ/4 Plate 26>

Uniaxial λ/4 plate (negative A plate) (nx<ny=nz, and Nz=0)

In-plane retardation: 137.5 nm

Azimuth of in-plane slow axis: 45°

### <First Retarder 27>

Negative C plate (nx=ny>nz)

Thickness direction retardation: 87.5 nm

### <First Substrate 8>

Color filter substrate

### <Second λ/4 Plate 30>

Uniaxial λ/4 plate (negative A plate) (nx<ny=nz, and Nz=0)

In-plane retardation: 137.5 nm

Azimuth of in-plane slow axis: −45°

### <Liquid Crystal Layer 11>

Nematic liquid crystal

Retardation: 340 nm

Alignment direction (with no voltage application): 90°

### <Second Substrate 12>

FFS mode thin-film transistor array substrate

### <Second Polarizing Plate 13>

Absorption polarizing plate

Azimuth of absorption axis: 90°

Azimuth of transmission axis: 0°

### Example 13

The same simulation sample as that of Example 12 was employed except that the first retarder 27 had a different thickness direction retardation of 62.5 nm.

### Example 14

The same simulation sample as that of Example 12 was employed except that the first retarder 27 had a different thickness direction retardation of 112.5 nm.

### Reference Example 1

Reference Example 1 relates to a conventional FFS mode liquid crystal display panel.

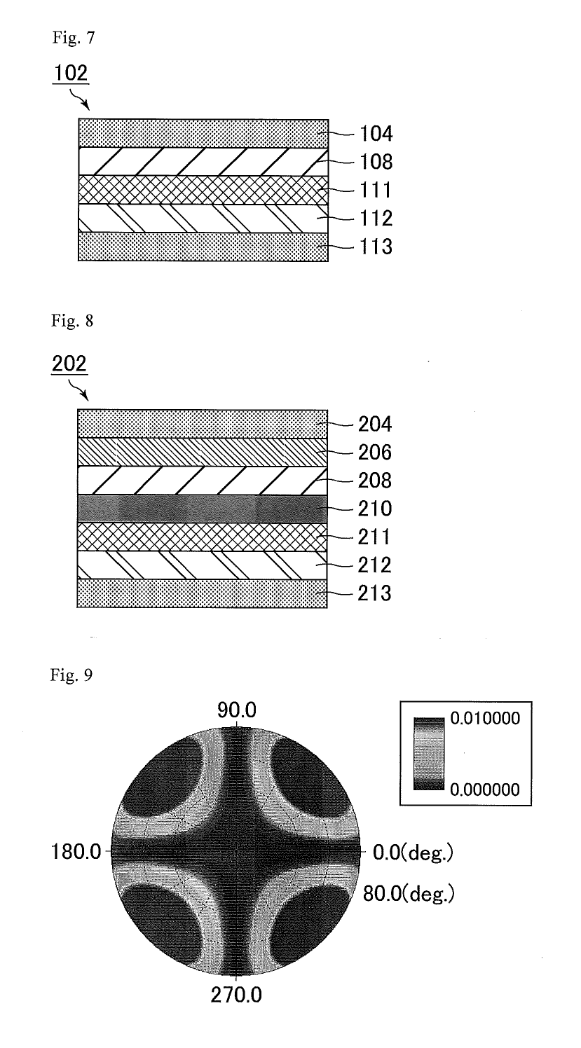

FIG. 7 is a schematic cross-sectional view illustrating the liquid crystal display panel according to Reference Example 1. As illustrated in FIG. 7, this liquid crystal display panel 102 includes a first polarizing plate 104, a first substrate 108, a liquid crystal layer 111, a second substrate 112, and a second polarizing plate 113 sequentially from the observation surface side toward the back surface side. Components of the liquid crystal display panel according to Reference Example 1 (simulation sample) were as follows.

### <First Polarizing Plate 104>

Absorption polarizing plate

Azimuth of absorption axis: 0°

Azimuth of transmission axis: 90°

### <First Substrate 108>

Color filter substrate

### <Liquid Crystal Layer 111>

Nematic liquid crystal

Retardation: 340 nm

Alignment direction (with no voltage application): 90°

### <Second Substrate 112>

FFS mode thin-film transistor array substrate

### <Second Polarizing Plate 113>

Absorption polarizing plate

Azimuth of absorption axis: 90°

Azimuth of transmission axis: 0°

### Comparative Example 1

FIG. 8 is a schematic cross-sectional view illustrating a liquid crystal display panel according to Comparative Example 1. As illustrated in FIG. 8, this liquid crystal display panel 202 includes a first polarizing plate 204, a first λ/4 plate 206, a first substrate 208, a second λ/4 plate 210, a liquid crystal layer 211, a second substrate 212, and a second polarizing plate 213 sequentially from the observation surface side toward the back surface side. Components of the liquid crystal display panel according to Comparative Example 1 (simulation sample) were as follows.

### <First Polarizing Plate 204>

Absorption polarizing plate

Azimuth of absorption axis: 0°

Azimuth of transmission axis: 90°

### <First λ/4 Plate 206>

Uniaxial λ/4 plate (positive A plate) (nx>ny=nz, and Nz=1.0)

In-plane retardation: 137.5 nm

Azimuth of in-plane slow axis: 45°

### <First Substrate 208>

Color filter substrate

### <Second λ/4 Plate 210>

Uniaxial λ/4 plate (positive A plate) (nx>ny=nz, and Nz=1.0)

In-plane retardation: 137.5 nm

Azimuth of in-plane slow axis: −45°

### <Liquid Crystal Layer 211>

Nematic liquid crystal

Retardation: 340 nm

Alignment direction (with no voltage application): 90°

### <Second Substrate 212>

FFS mode thin-film transistor array substrate

### <Second Polarizing Plate 213>

Absorption polarizing plate

Azimuth of absorption axis: 90°

Azimuth of transmission axis: 0°

### Comparative Example 2

The same simulation sample as that of Comparative Example 1 was employed except that the first λ/4 plate 206 and the second λ/4 plate 210 were changed as described below.

### <First λ/4 Plate 206>

Uniaxial λ/4 plate (negative A plate) (nx<ny=nz, and Nz=0)

In-plane retardation: 137.5 nm

Azimuth of in-plane slow axis: 45°

### <Second λ/4 Plate 210>

Uniaxial λ/4 plate (negative A plate) (nx<ny=nz, and Nz=0)

In-plane retardation: 137.5 nm

Azimuth of in-plane slow axis: −45°

### [Evaluation 1]

Simulation was performed on the viewing angle characteristic of transmittance (the relation between transmittance and each of an azimuth angle and a polar angle) for Example 1, Example 11, Reference Example 1, and Comparative Example 1.

### (Evaluation Method)

Simulation of transmittance in the black display state (with no voltage application) was performed for light having a wavelength of 550 nm by using a liquid crystal optical simulator (product name: LCD Master) manufactured by Shintech Inc. Simulation calculation was performed for azimuth angles at 50 intervals in the range of 0 to 360° and polar angles at 100 intervals in the range of 0 to 80°. Then, a contour diagram of each example was produced by plotting obtained calculated values as a contour.

### (Evaluation Result)

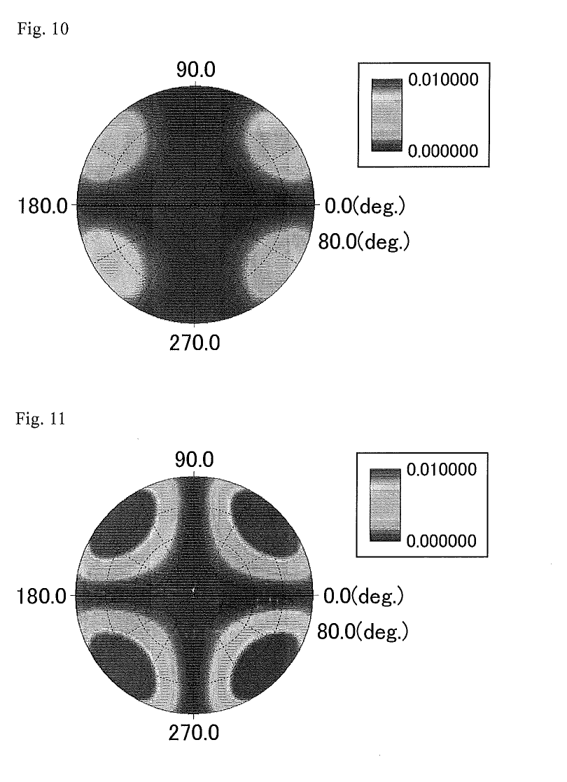

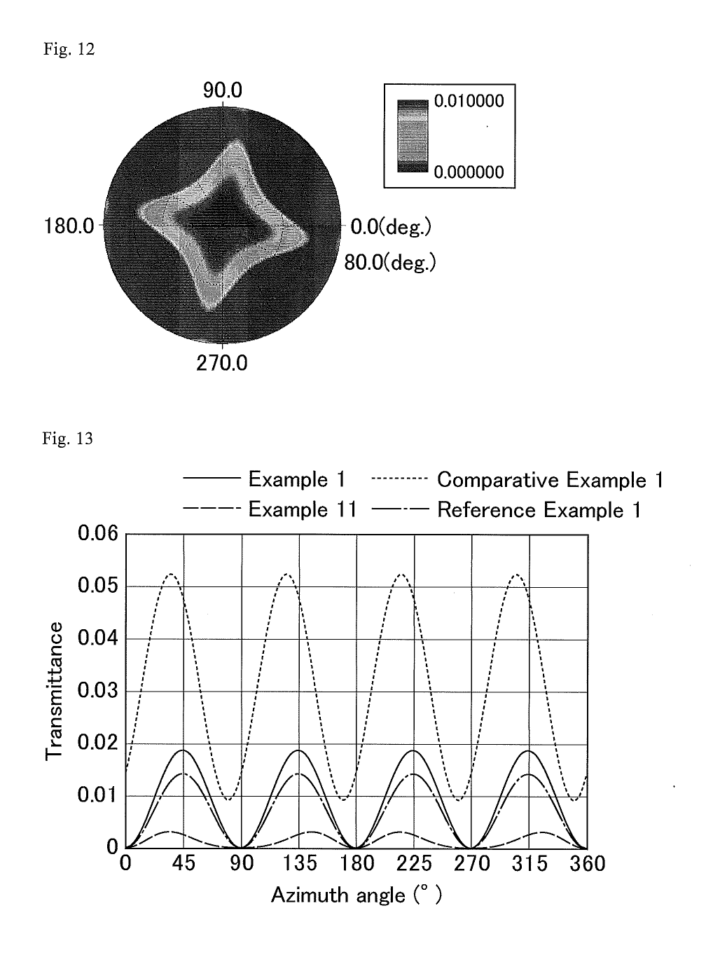

FIG. 9 is a contour diagram illustrating a simulation result of the viewing angle characteristic of transmittance for the liquid crystal display panel according to Example 1. FIG. 10 is a contour diagram illustrating a simulation result of the viewing angle characteristic of transmittance for the liquid crystal display panel according to Example 11. FIG. 11 is a contour diagram illustrating a simulation result of the viewing angle characteristic of transmittance for the liquid crystal display panel according to Reference Example 1. FIG. 12 is a contour diagram illustrating a simulation result of the viewing angle characteristic of transmittance for the liquid crystal display panel according to Comparative Example 1. In each simulation result, the center of a circle indicates a calculation result at the polar angle of 0°, and a point on the outermost circumference indicates a calculation result at the polar angle of 80°.

FIG. 13 illustrates a cross-sectional view at the polar angle of 60° to facilitate understanding of the simulation results in FIGS. 9 to 12. FIG. 13 is a graph illustrating a section taken at the polar angle of 60° in each of the contour diagrams illustrated in FIGS. 9 to 12.

As illustrated in FIGS. 9 to 11, the viewing angle characteristic of Examples 1 and 11 was equivalent to or more excellent than that of Reference Example 1. Specifically, according to Examples 1 and 11, similarly to Reference Example 1, an excellent black display state was achieved even when observed in an oblique direction. The viewing angle characteristic of Example 11 was more excellent than that of Example 1. This is because viewing angle correction was performed for the first polarizing plate 4 and the second polarizing plate 13 by the second retarder 18 (negative A plate) in Example 11. As illustrated in FIGS. 9 to 12, the viewing angle characteristic of Comparative Example 1 was less excellent than those of Example 1, Example 11, and Reference Example 1, and in particular, the viewing angle in an oblique direction was narrow. This is because a retarder (for example, the first retarder 7 according to Example 1) for achieving optimization (optical compensation) of change of the polarization state in an oblique direction is not disposed between the first λ/4 plate 206 and the second λ/4 plate 210 in Comparative Example 1. This can be understood also from FIG. 13.

The above-described difference in the viewing angle characteristic is explained as follows by using a Poincare sphere.

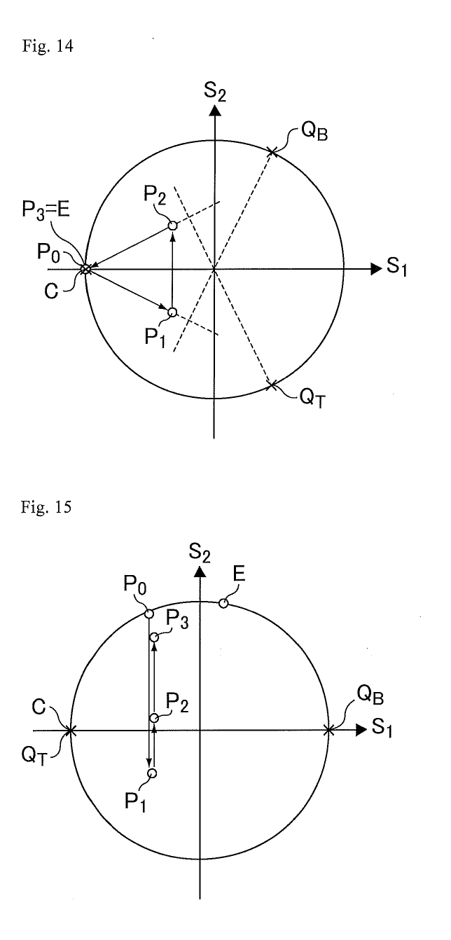

FIG. 14 is a diagram obtained by projecting, onto the S₁-S₂ plane of a Poincare sphere, polarization states before and after transmission through each component of the liquid crystal display panel according to Example 1 when observed in a direction at the azimuth angle of 0° and the polar angle of 60°. As illustrated in FIG. 14, first, the polarization state of incident light from the back surface side right after having sequentially transmitted through the second polarizing plate 13, the second substrate 12, and the liquid crystal layer 11 (with no voltage application) is positioned at Point P₀. Point P₀ coincides with the extinction position (azimuth of the absorption axis) of the first polarizing plate 4, which is indicated by Point E. Then, as the light transmits through the second λ/4 plate 10, the polarization state being positioned at Point P₀ is rotated by 90° about the in-plane slow axis of the second λ/4 plate 10, which is indicated by Point Q_{B}, and reaches Point P₁. The direction of the rotation is anticlockwise in a view toward the origin (center point of the Poincare sphere) from Point Q_{B}. Subsequently, as the light sequentially transmits through the first substrate 8 and the first retarder 7, the polarization state being positioned at Point P₁ reaches Point P₂. Thereafter, as the light transmits through the first λ/4 plate 6, the polarization state being positioned at Point P₂ is rotated by 90° about the in-plane slow axis of the first λ/4 plate 6, which is indicated by Point Q_{T}, and reaches Point P₃. The direction of the rotation is anticlockwise in a view toward the origin (center point of the Poincare sphere) from Point Q_{T}. As a result, Point P₃ coincides with the extinction position (azimuth of the absorption axis) of the first polarizing plate 4, which is indicated by Point E.

FIG. 15 is a diagram obtained by projecting, onto the S₁-S₂ plane of a Poincare sphere, polarization states before and after transmission through each component of the liquid crystal display panel according to Example 1 when observed in a direction at the azimuth angle of 45° and the polar angle of 60°. As illustrated in FIG. 15, first, the polarization state of incident light from the back surface side right after having sequentially transmitted through the second polarizing plate 13, the second substrate 12, and the liquid crystal layer 11 (with no voltage application) is positioned at Point P₀. Then, as the light transmits through the second λ/4 plate 10, the polarization state being positioned at Point P₀ is rotated by 90° about the in-plane slow axis of the second λ/4 plate 10, which is indicated by Point Q_{B}, and reaches Point P₁. The direction of the rotation is anticlockwise in a view toward the origin (center point of the Poincare sphere) from Point Q_{B}. Subsequently, as the light sequentially transmits through the first substrate 8 and the first retarder 7, the polarization state being positioned at Point P₁ reaches Point P₂. Thereafter, as the light transmits through the first λ/4 plate 6, the polarization state being positioned at Point P₂ is rotated by 90° about the in-plane slow axis of the first λ/4 plate 6, which is indicated by Point Q_{T}, and reaches Point P₃. The direction of the rotation is anticlockwise in a view toward the origin (center point of the Poincare sphere) from Point Q_{T}. As a result, Point P₃ does not coincide with the extinction position (azimuth of the absorption axis) of the first polarizing plate 4, which is indicated by Point E.

Accordingly, a more excellent black display state can be obtained when the liquid crystal display panel according to Example 1 is observed in a direction at the azimuth angle of 0° and the polar angle of 60° than when the liquid crystal display panel is observed in a direction at the azimuth angle of 45° and the polar angle of 60°. This result is as illustrated in FIG. 13.

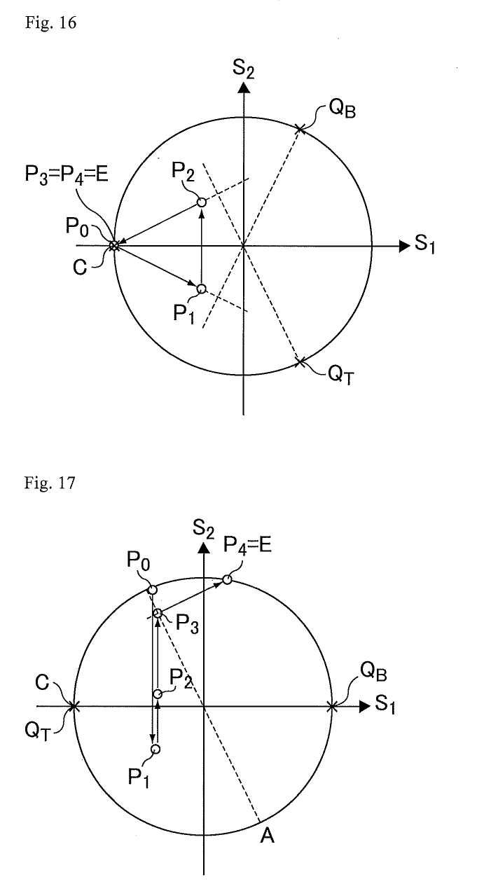

FIG. 16 is a diagram obtained by projecting, onto the S₁-S₂ plane of a Poincare sphere, polarization states before and after transmission through each component of the liquid crystal display panel according to Example 11 when observed in a direction at the azimuth angle of 0° and the polar angle of 60°. As illustrated in FIG. 16, first, the polarization state of incident light from the back surface side right after having sequentially transmitted through the second polarizing plate 13, the second substrate 12, and the liquid crystal layer 11 (with no voltage application) is positioned at Point P₀. Point P₀ coincides with the extinction position (azimuth of the absorption axis) of the first polarizing plate 4, which is indicated by Point E. Then, as the light transmits through the second λ/4 plate 10, the polarization state being positioned at Point P₀ is rotated by 90° about the in-plane slow axis of the second λ/4 plate 10, which is indicated by Point Q_{B}, and reaches Point P₁. The direction of the rotation is anticlockwise in a view toward the origin (center point of the Poincare sphere) from Point Q_{B}. Subsequently, as the light sequentially transmits through the first substrate 8 and the first retarder 7, the polarization state being positioned at Point P_{L} reaches Point P₂. Subsequently, as the light transmits through the first λ/4 plate 6, the polarization state being positioned at Point P₂ is rotated by 90° about the in-plane slow axis of the first λ/4 plate 6, which is indicated by Point Q_{T}, and reaches Point P₃. The direction of the rotation is anticlockwise in a view toward the origin (center point of the Poincare sphere) from Point Q_{T}. Thereafter, the light transmits through the second retarder 18, but the polarization state being positioned at Point P₃ does not change and is positioned at Point P₄, which is the same as Point P₃. As a result, Point P₄ coincides with the extinction position (azimuth of the absorption axis) of the first polarizing plate 4, which is indicated by Point E.

FIG. 17 is a diagram obtained by projecting, onto the S₁-S₂ plane of a Poincare sphere, polarization states before and after transmission through each component of the liquid crystal display panel according to Example 11 when observed in a direction at the azimuth angle of 45° and the polar angle of 60°. As illustrated in FIG. 17, first, the polarization state of incident light from the back surface side right after having sequentially transmitted through the second polarizing plate 13, the second substrate 12, and the liquid crystal layer 11 (with no voltage application) is positioned at Point P₀. Then, as the light transmits through the second λ/4 plate 10, the polarization state being positioned at Point P₀ is rotated by 90° about the in-plane slow axis of the second λ/4 plate 10, which is indicated by Point Q_{B}, and reaches Point P₁. The direction of the rotation is anticlockwise in a view toward the origin (center point of the Poincare sphere) from Point Q_{B}. Subsequently, as the light sequentially transmits through the first substrate 8 and the first retarder 7, the polarization state being positioned at Point P₁ reaches Point P₂. Subsequently, as the light transmits through the first λ/4 plate 6, the polarization state being positioned at Point P₂ is rotated by 90° about the in-plane slow axis of the first λ/4 plate 6, which is indicated by Point Q_{T}, and reaches Point P₃. The direction of the rotation is anticlockwise in a view toward the origin (center point of the Poincare sphere) from Point Q_{T}. Thereafter, as the light transmits through the second retarder 18, the polarization state being positioned at Point P₃ reaches Point P₄. As a result, Point P₄ coincides with the extinction position (azimuth of the absorption axis) of the first polarizing plate 4, which is indicated by Point E.

Accordingly, an excellent black display state can be obtained either when the liquid crystal display panel according to Example 11 is observed in a direction at the azimuth angle of 0° and the polar angle of 60° or in a direction at the azimuth angle of 45° and the polar angle of 60°. When observed in a direction at the azimuth angle of 45° and the polar angle of 60°, the liquid crystal display panel according to Example 11 achieves a more excellent black display state than the liquid crystal display panel according to Example 1. This result is as illustrated in FIG. 13.

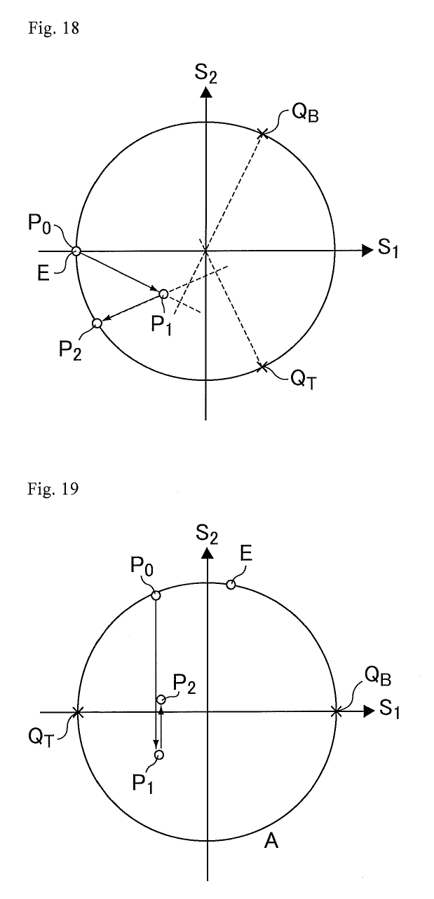

FIG. 18 is a diagram obtained by projecting, onto the S₁-S₂ plane of a Poincare sphere, polarization states before and after transmission through each component of the liquid crystal display panel according to Comparative Example 1 when observed in a direction at the azimuth angle of 0° and the polar angle of 60°. As illustrated in FIG. 18, first, the polarization state of incident light from the back surface side right after having sequentially transmitted through the second polarizing plate 213, the second substrate 212, and the liquid crystal layer 211 (with no voltage application) is positioned at Point P₀. Point P₀ coincides with the extinction position (azimuth of the absorption axis) of the first polarizing plate 204, which is indicated by Point E. Then, as the light transmits through the second λ/4 plate 210, the polarization state being positioned at Point P₀ is rotated by 90° about the in-plane slow axis of the second λ/4 plate 210, which is indicated by Point Q_{B}, and reaches Point P₁. The direction of the rotation is anticlockwise in a view toward the origin (center point of the Poincare sphere) from Point Q_{B}. Subsequently, as the light sequentially transmits through the first substrate 208 and the first λ/4 plate 206, the polarization state being positioned at Point P₁ is rotated by 90° about the in-plane slow axis of the first λ/4 plate 206, which is indicated by Point Q_{T}, and reaches Point P₂. The direction of the rotation is anticlockwise in a view toward the origin (center point of the Poincare sphere) from Point Q_{T}. As a result, Point P₂ does not coincide with the extinction position (azimuth of the absorption axis) of the first polarizing plate 204, which is indicated by Point E.

FIG. 19 is a diagram obtained by projecting, onto the S₁-S₂ plane of a Poincare sphere, polarization states before and after transmission through each component of the liquid crystal display panel according to Comparative Example 1 when observed in a direction at the azimuth angle of 45° and the polar angle of 60°. As illustrated in FIG. 19, first, the polarization state of incident light from the back surface side right after having sequentially transmitted through the second polarizing plate 213, the second substrate 212, and the liquid crystal layer 211 (with no voltage application) is positioned at Point P₀. Then, as the light transmits through the second λ/4 plate 210, the polarization state being positioned at Point P₀ is rotated by 90° about the in-plane slow axis of the second λ/4 plate 210, which is indicated by Point Q_{B}, and reaches Point P₁. The direction of the rotation is anticlockwise in a view toward the origin (center point of the Poincare sphere) from Point Q_{B}. Subsequently, as the light sequentially transmits through the first substrate 208 and the first λ/4 plate 206, the polarization state being positioned at Point P₁ is rotated by 90° about the in-plane slow axis of the first λ/4 plate 206, which is indicated by Point Q_{T}, and reaches Point P₂. The direction of the rotation is anticlockwise in a view toward the origin (center point of the Poincare sphere) from Point Q_{T}. As a result, Point P₂ does not coincide with the extinction position (azimuth of the absorption axis) of the first polarizing plate 204, which is indicated by Point E.

Accordingly, a more excellent black display state than those achieved by the liquid crystal display panel according to Example 1 and the liquid crystal display panel according to Example 11 is achieved neither when the liquid crystal display panel according to Comparative Example 1 is observed in a direction at the azimuth angle of 0° and the polar angle of 60° nor in a direction at the azimuth angle of 45° and the polar angle of 60°. This result is as illustrated in FIG. 13.

### [Evaluation 2]

Simulation was performed on the viewing angle characteristic of transmittance (the relation between transmittance and each of an azimuth angle and a polar angle) for Examples 1, 2, and 3 by the same evaluation method as that of [Evaluation 1] described above.

### (Evaluation Result)

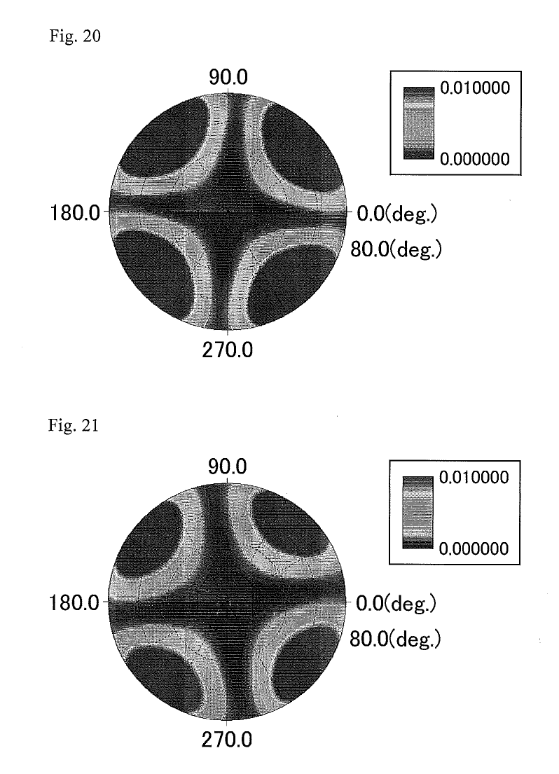

A simulation result of Example 1 is as already illustrated in FIG. 9. FIG. 20 is a contour diagram illustrating a simulation result of the viewing angle characteristic of transmittance for the liquid crystal display panel according to Example 2. FIG. 21 is a contour diagram illustrating a simulation result of the viewing angle characteristic of transmittance for the liquid crystal display panel according to Example 3.

The viewing angle characteristic was equivalent between Examples 1, 2, and 3 as illustrated in FIGS. 9, 20, and 21.

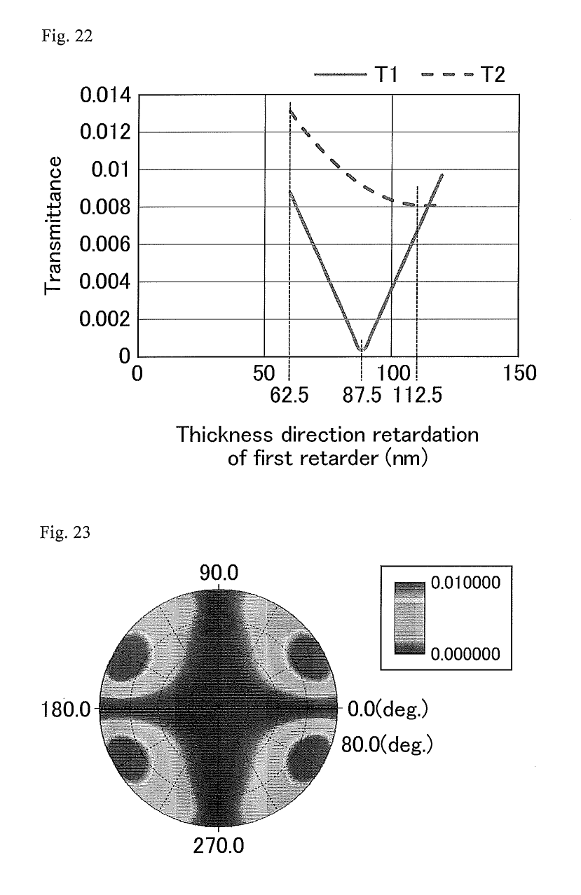

The following describes, with reference to FIG. 22, effects of difference in the thickness direction retardation of the first retarder 7 when the first λ/4 plate 6 and the second λ/4 plate 10 are uniaxial λ/4 plates (nx>ny=nz, and Nz=1.0). FIG. 22 is a graph illustrating the relation between the thickness direction retardation of the first retarder and transmittance when the first λ/4 plate and the second λ/4 plate are uniaxial λ/4 plates (nx>ny=nz, and Nz=1.0).

In FIG. 22, T1 represents the absolute value of the difference between transmittance when observation is made in a direction at the azimuth angle of 25° and the polar angle of 60° and transmittance when observation is made in a direction at the azimuth angle of 65° and the polar angle of 60°, in the black display state (with no voltage application). T1 decreases as the symmetric property of the viewing angle characteristic with respect to a direction at the azimuth angle of 45° improves. As a result of calculations of T1 with different thickness direction retardations of the first retarder 7, T1 was minimum when the thickness direction retardation was 87.5 nm (Example 1) as illustrated in FIG. 22. Thus, when the first λ/4 plate 6 and the second λ/4 plate 10 are uniaxial λ/4 plates (nx>ny=nz, and Nz=1.0), Example 1 is preferably employed if an improvement in the symmetric property of the viewing angle characteristic is desired.

In FIG. 22, T2 represents the average value of transmittance when observation is made in directions at the azimuth angles of 0 to 360° (50 intervals) and the polar angle of 60° in the black display state (with no voltage application). T2 decreases as the transmittance decreases on average irrespective of the azimuth angle (light leakage is low in the black display state). As a result of calculations of T2 with different thickness direction retardations of the first retarder 7, T2 was minimum when the thickness direction retardation was 112.5 nm (Example 3) as illustrated in FIG. 22. Thus, when the first λ/4 plate 6 and the second λ/4 plate 10 are uniaxial λ/4 plates (nx>ny=nz, and Nz=1.0), Example 3 is preferably employed if a small average value of transmittance is desired.

Accordingly, in the first liquid crystal display panel according to the present invention, the first retarder 7 preferably has a thickness direction retardation of 87.5 nm or more and 112.5 nm or less when the principal refractive indexes of the first λ/4 plate 6 and the second λ/4 plate 10 satisfy the relation of ny=nz, in other words, satisfy the relation of nx>ny=nz (uniaxial λ/4 plate: positive A plate). A preferable range of the thickness direction retardation of the first retarder 7 depends on a designing concept (whether to focus on the symmetric property of the viewing angle characteristic or the average value of transmittance) of the liquid crystal display panel.

### [Evaluation 3]

Simulation was performed on the viewing angle characteristic of transmittance (the relation between transmittance and each of an azimuth angle and a polar angle) for Examples 1 and 4 by the same evaluation method as that of [Evaluation 1] described above.

### (Evaluation Result)

A simulation result of Example 1 is as already illustrated in FIG. 9. FIG. 23 is a contour diagram illustrating a simulation result of the viewing angle characteristic of transmittance for the liquid crystal display panel according to Example 4.

As illustrated in FIGS. 9 and 23, the viewing angle characteristic of Example 4 was equivalent to or more excellent than that of Example 1.

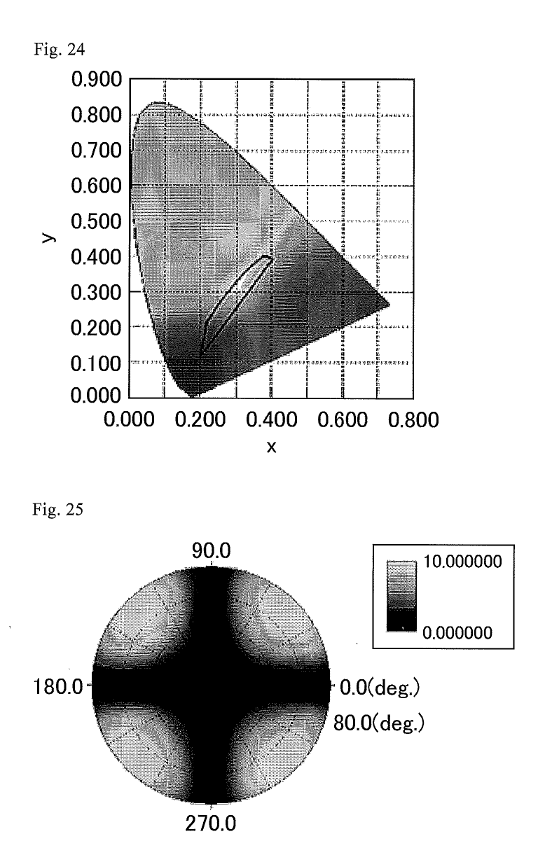

The following describes effects due to difference in the relation between the alignment direction of the nematic liquid crystal in the liquid crystal layer 11 and the absorption axis of the second polarizing plate 13 with no voltage application. The liquid crystal display panels according to Examples 1 and 4 were actually produced and evaluated, and it was found that a more excellent coloring state was obtained for the liquid crystal display panel according to Example 1 than the liquid crystal display panel according to Example 4 when observed in an oblique direction. Specifically, when 10 evaluators subjectively evaluated the liquid crystal display panels, nine of the evaluators evaluated that the liquid crystal display panel according to Example 4 visually changed to various colors depending on the direction of observation, and the liquid crystal display panel according to Example 1 had a more excellent black display quality. This phenomenon was observed from results (FIGS. 24 to 27) of simulation calculation in which the wavelength of light is increased from the single wavelength of 550 nm to the wavelength region of visible light (380 to 780 nm) with influence of wavelength dispersion taken into account.

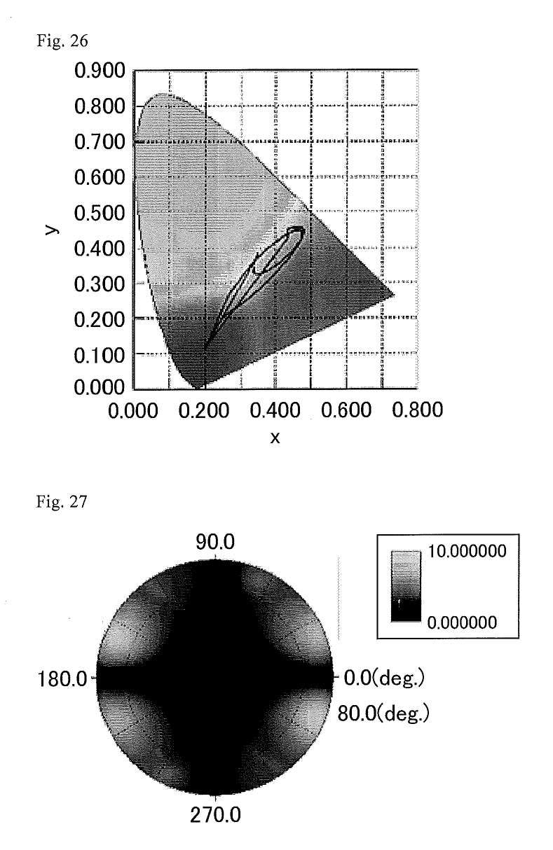

FIG. 24 is an xy chromaticity diagram derived from a transmittance calculation result for the liquid crystal display panel according to Example 1. FIG. 25 is a contour diagram illustrating an image of the coloring state of the liquid crystal display panel according to Example 1. FIG. 26 is an xy chromaticity diagram derived from a transmittance calculation result for the liquid crystal display panel according to Example 4. FIG. 27 is a contour diagram illustrating an image of the coloring state of the liquid crystal display panel according to Example 4. FIGS. 24 and 26 are obtained by performing visual sensitivity correction on transmittance calculation results for light in the wavelength region of visible light (380 to 780 nm) and converting the results into chromaticity coordinates (x, y), illustrating chromaticity change in directions at the azimuth angles of 0 to 360° and the polar angle of 60°. In each of FIGS. 25 and 27, the center of a circle indicates a calculation result at the polar angle of 0°, and a point on the outermost circumference indicates a calculation result at the polar angle of 80°. As illustrated in FIGS. 24 to 27, it was found that the liquid crystal display panel according to Example 4 changes to more various colors depending on the observation direction than the liquid crystal display panel according to Example 1.

Accordingly, Example 1 is preferably employed if an excellent coloring state is desired (an improvement in the black display quality is desired). In other words, the alignment direction of the nematic liquid crystal in the liquid crystal layer 11 and the absorption axis of the second polarizing plate 13 are preferably parallel to each other with no voltage application.

### [Evaluation 4]

Simulation was performed on the viewing angle characteristic of transmittance (the relation between transmittance and each of an azimuth angle and a polar angle) for Examples 1 and 5 by the same evaluation method as that of [Evaluation 1] described above.

### (Evaluation Result)

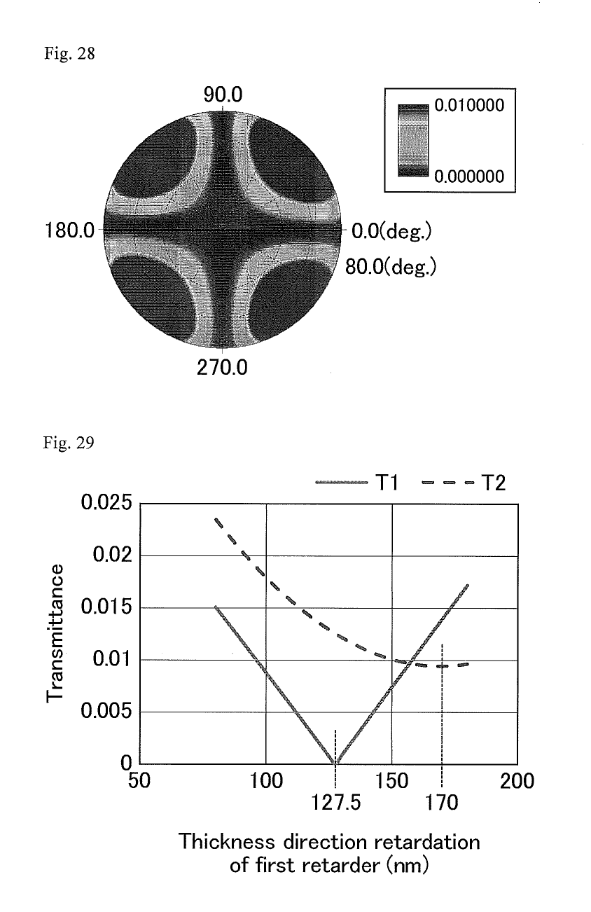

A simulation result of Example 1 is as already illustrated in FIG. 9. FIG. 28 is a contour diagram illustrating a simulation result of the viewing angle characteristic of transmittance for the liquid crystal display panel according to Example 5.

The viewing angle characteristic was equivalent between Examples 1 and 5 as illustrated in FIGS. 9 and 28.

The following describes, with reference to FIG. 29, effects of difference in the thickness direction retardation of the first retarder 7 when the first λ/4 plate 6 is a biaxial λ/4 plate (nx>ny>nz, and Nz=1.5) and the second λ/4 plate 10 is a uniaxial λ/4 plate (nx>ny=nz, and Nz=1.0). FIG. 29 is a graph illustrating the relation between the thickness direction retardation of the first retarder and transmittance when the first λ/4 plate is a biaxial λ/4 plate (nx>ny>nz, and Nz=1.5) and the second λ/4 plate is a uniaxial λ/4 plate (nx>ny=nz, and Nz=1.0).

In FIG. 29, T1 represents the absolute value of the difference between transmittance when observation is made in a direction at the azimuth angle of 25° and the polar angle of 60° and transmittance when observation is made in a direction at the azimuth angle of 65° and the polar angle of 60°, in the black display state (with no voltage application). T1 decreases as the symmetric property of the viewing angle characteristic with respect to a direction at the azimuth angle of 45° improves. As a result of calculations of T1 with different thickness direction retardations of the first retarder 7, T1 was minimum when the thickness direction retardation was 127.5 nm (Example 5) as illustrated in FIG. 29. Thus, Example 5 is preferably employed if an improvement in the symmetric property of the viewing angle characteristic is desired when the first λ/4 plate 6 is a biaxial λ/4 plate (nx>ny>nz, and Nz=1.5) and the second λ/4 plate 10 is a uniaxial λ/4 plate (nx>ny=nz, and Nz=1.0).

In FIG. 29, T2 represents the average value of transmittance when observation is made in directions at the azimuth angles of 0 to 360° (50 intervals) and the polar angle of 60° in the black display state (with no voltage application). T2 decreases as the transmittance decreases on average irrespective of the azimuth angle (light leakage is low in the black display state). As a result of calculations of T2 with different thickness direction retardations of the first retarder 7, T2 was minimum when the thickness direction retardation was 170 nm as illustrated in FIG. 29. Thus, the thickness direction retardation of the first retarder 7 is preferably 170 nm if a small average value of transmittance is desired when the first λ/4 plate 6 is a biaxial λ/4 plate (nx>ny>nz, and Nz=1.5) and the second λ/4 plate 10 is a uniaxial λ/4 plate (nx>ny=nz, and Nz=1.0).

### [Evaluation 5]

Simulation was performed on the viewing angle characteristic of transmittance (the relation between transmittance and each of an azimuth angle and a polar angle) for Examples 1 and 6 by the same evaluation method as that of [Evaluation 1] described above.

### (Evaluation Result)

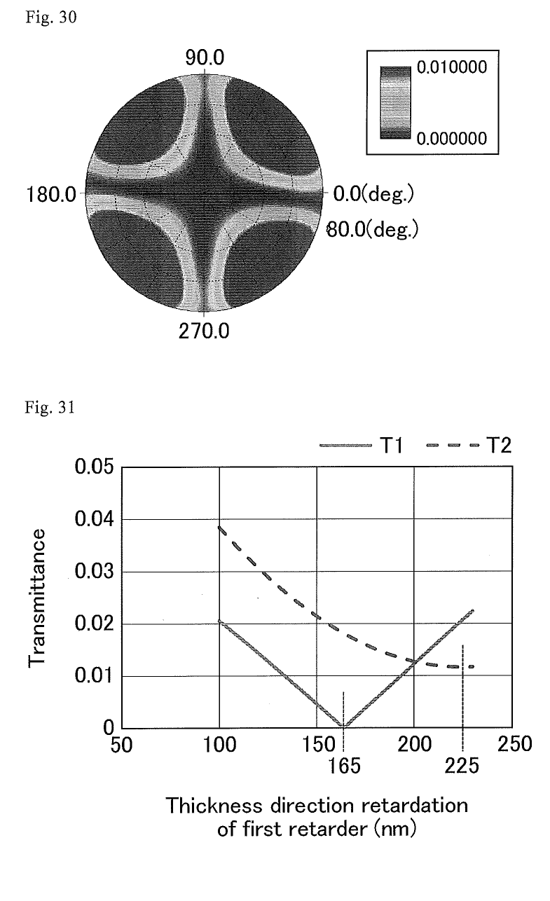

A simulation result of Example 1 is as already illustrated in FIG. 9. FIG. 30 is a contour diagram illustrating a simulation result of the viewing angle characteristic of transmittance for the liquid crystal display panel according to Example 6.

The viewing angle characteristic was equivalent between Examples 1 and 6 as illustrated in FIGS. 9 and 30.

The following describes, with reference to FIG. 31, effects of difference in the thickness direction retardation of the first retarder 7 when the first λ/4 plate 6 is a biaxial λ/4 plate (nx>ny>nz, and Nz=2.0) and the second λ/4 plate 10 is a uniaxial λ/4 plate (nx>ny=nz, and Nz=1.0). FIG. 31 is a graph illustrating the relation between the thickness direction retardation of the first retarder and transmittance when the first λ/4 plate is a biaxial λ/4 plate (nx>ny>nz, and Nz=2.0) and the second λ/4 plate is a uniaxial λ/4 plate (nx>ny=nz, and Nz=1.0).

In FIG. 31, T1 represents the absolute value of the difference between transmittance when observation is made in a direction at the azimuth angle of 25° and the polar angle of 60° and transmittance when observation is made in a direction at the azimuth angle of 65° and the polar angle of 60°, in the black display state (with no voltage application). T1 decreases as the symmetric property of the viewing angle characteristic with respect to a direction at the azimuth angle of 45° improves. As a result of calculations of T1 with different thickness direction retardations of the first retarder 7, T1 was minimum when the thickness direction retardation was 165 nm (Example 6) as illustrated in FIG. 31. Thus, Example 6 is preferably employed if an improvement in the symmetric property of the viewing angle characteristic is desired when the first λ/4 plate 6 is a biaxial λ/4 plate (nx>ny>nz, and Nz=2.0) and the second λ/4 plate 10 is a uniaxial λ/4 plate (nx>ny=nz, and Nz=1.0).

In FIG. 31, T2 represents the average value of transmittance when observation is made in directions at the azimuth angles of 0 to 360° (50 intervals) and the polar angle of 60° in the black display state (with no voltage application). T2 decreases as the transmittance decreases on average irrespective of the azimuth angle (light leakage is low in the black display state). As a result of calculations of T2 with different thickness direction retardations of the first retarder 7, T2 was minimum when the thickness direction retardation was 225 nm as illustrated in FIG. 31. Thus, the thickness direction retardation of the first retarder 7 is preferably 225 nm if a small average value of transmittance is desired when the first λ/4 plate 6 is a biaxial λ/4 plate (nx>ny>nz, and Nz=2.0) and the second λ/4 plate 10 is a uniaxial λ/4 plate (nx>ny=nz, and Nz=1.0).

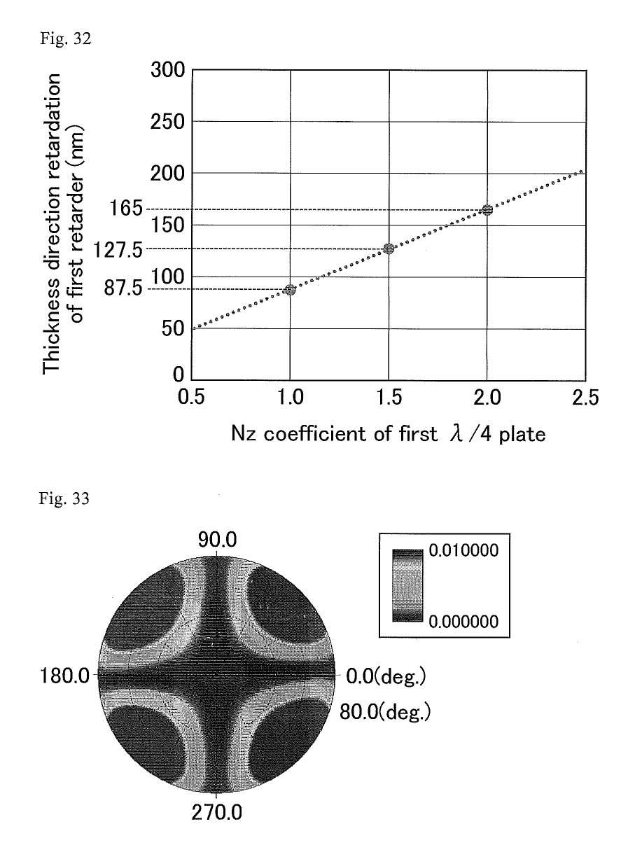

FIG. 32 illustrates, based on the above-described evaluation results of [Evaluation 2], [Evaluation 4], and [Evaluation 5], the relation between the Nz coefficient of the first λ/4 plate 6 and the optimum value of the thickness direction retardation of the first retarder 7 when focus is on the symmetric property of the viewing angle characteristic. FIG. 32 is a graph illustrating the relation between the Nz coefficient of the first λ/4 plate and the optimum value of the thickness direction retardation of the first retarder when focus is on the symmetric property of the viewing angle characteristic, which is derived from FIGS. 22, 29, and 31. As illustrated in FIG. 32, the Nz coefficient of the first λ/4 plate 6 and the optimum value of the thickness direction retardation of the first retarder 7 have a linear relation therebetween. Thus, when focus is on the symmetric property of the viewing angle characteristic, a combination of the Nz coefficient of the first λ/4 plate 6 and the thickness direction retardation of the first retarder 7 is to be selected based on FIG. 32.

As understood from comparison between FIGS. 22, 29, and 31, the optimum value of the thickness direction retardation of the first retarder 7 is higher when the first λ/4 plate 6 is a biaxial λ/4 plate (FIGS. 29 and 31) than when the first λ/4 plate 6 is a uniaxial λ/4 plate (FIG. 22). This is qualitatively understood as follows. The thickness direction retardation of the first λ/4 plate 6 is, for example, −68.75 nm for Nz=1.0, and −137.5 nm for Nz=1.5. Thus, as the Nz coefficient of the first λ/4 plate 6 increases, the thickness direction retardation thereof (in the above-described example, 68.75 nm) decreases, and thus the thickness direction retardation of the first retarder 7 needs to be increased to compensate the decrease. Specifically, when the first λ/4 plate 6 is changed from a uniaxial λ/4 plate to a biaxial λ/4 plate, an effect equivalent to that when the first λ/4 plate 6 is a uniaxial λ/4 plate can be obtained by adjusting the thickness direction retardation of the first retarder 7 with taken into account change in the thickness direction retardation thereof.

### [Evaluation 6]

Simulation was performed on the viewing angle characteristic of transmittance (the relation between transmittance and each of an azimuth angle and a polar angle) for Examples 1, 7, and 8 by the same evaluation method as that of [Evaluation 1] described above.

### (Evaluation Result)

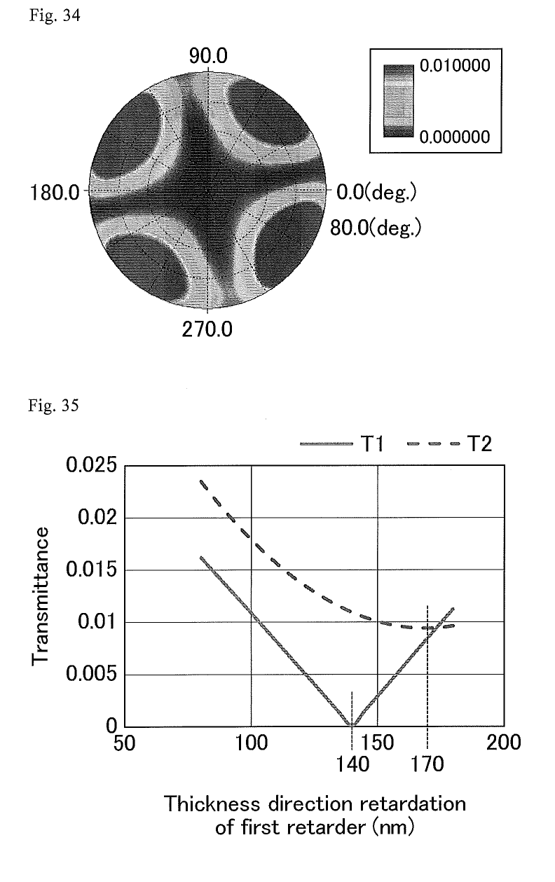

A simulation result of Example 1 is as already illustrated in FIG. 9. FIG. 33 is a contour diagram illustrating a simulation result of the viewing angle characteristic of transmittance for the liquid crystal display panel according to Example 7. FIG. 34 is a contour diagram illustrating a simulation result of the viewing angle characteristic of transmittance for the liquid crystal display panel according to Example 8.

The viewing angle characteristic was equivalent between Examples 1, 7, and 8 as illustrated in FIGS. 9, 33, and 34.

The following describes, with reference to FIG. 35, effects of difference in the thickness direction retardation of the first retarder 7 when the first λ/4 plate 6 is a uniaxial λ/4 plate (nx>ny=nz, and Nz=1.0) and the second λ/4 plate 10 is a biaxial λ/4 plate (nx>ny>nz, and Nz=1.5). FIG. 35 is a graph illustrating the relation between the thickness direction retardation of the first retarder and transmittance when the first λ/4 plate is a uniaxial λ/4 plate (nx>ny=nz, and Nz=1.0) and the second λ/4 plate is a biaxial λ/4 plate (nx>ny>nz, and Nz=1.5).

In FIG. 35, T1 represents the absolute value of the difference between transmittance when observation is made in a direction at the azimuth angle of 25° and the polar angle of 60° and transmittance when observation is made in a direction at the azimuth angle of 65° and the polar angle of 60°, in the black display state (with no voltage application). T1 decreases as the symmetric property of the viewing angle characteristic with respect to a direction at the azimuth angle of 45° improves. As a result of calculations of T1 with different thickness direction retardations of the first retarder 7, T1 was minimum when the thickness direction retardation was 140 nm (Example 7) as illustrated in FIG. 35. Thus, Example 7 is preferably employed if an improvement in the symmetric property of the viewing angle characteristic is desired when the first λ/4 plate 6 is a uniaxial λ/4 plate (nx>ny=nz, and Nz=1.0) and the second λ/4 plate 10 is a biaxial λ/4 plate (nx>ny>nz, and Nz=1.5).

In FIG. 35, T2 represents the average value of transmittance when observation is made in directions at the azimuth angles of 0 to 360° (50 intervals) and the polar angle of 60° in the black display state (with no voltage application). T2 decreases as the transmittance decreases on average irrespective of the azimuth angle (light leakage is low in the black display state). As a result of calculations of T2 with different thickness direction retardations of the first retarder 7, T2 was minimum when the thickness direction retardation was 170 nm (Example 8) as illustrated in FIG. 35. Thus, Example 8 is preferably employed if a small average value of transmittance is desired when the first λ/4 plate 6 is a uniaxial λ/4 plate (nx>ny=nz, and Nz=1.0) and the second λ/4 plate 10 is a biaxial λ/4 plate (nx>ny>nz, and Nz=1.5).

As understood from comparison between FIGS. 22 and 35, the optimum value of the thickness direction retardation of the first retarder 7 is higher when the second λ/4 plate 10 is a biaxial λ/4 plate (FIG. 35) than when the second λ/4 plate 10 is a uniaxial λ/4 plate (FIG. 22). This is qualitatively understood as follows. The thickness direction retardation of the second λ/4 plate 10 is, for example, −68.75 nm for Nz=1.0, and −137.5 nm for Nz=1.5. Thus, as the Nz coefficient of the second λ/4 plate 10 increases, the thickness direction retardation thereof (in the above-described example, 68.75 nm) decreases, and the thickness direction retardation of the first retarder 7 needs to be increased to compensate the decrease. Specifically, when the second λ/4 plate 10 is changed from a uniaxial λ/4 plate to a biaxial λ/4 plate, an effect equivalent to that when the second λ/4 plate 10 is a uniaxial λ/4 plate can be obtained by adjusting the thickness direction retardation of the first retarder 7 with taken into account change in the thickness direction retardation thereof.

### [Evaluation 7]

Simulation was performed on the viewing angle characteristic of transmittance (the relation between transmittance and each of an azimuth angle and a polar angle) for Examples 1, 9, and 10 by the same evaluation method as that of [Evaluation 1] described above.

### (Evaluation Result)

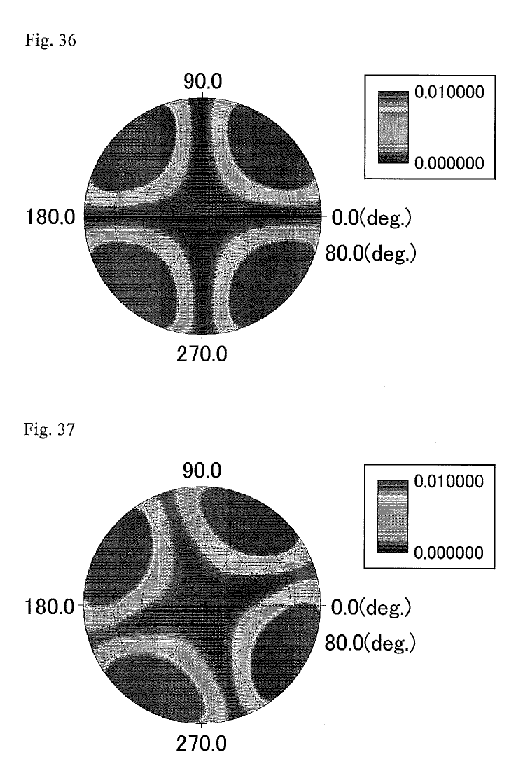

A simulation result of Example 1 is as already illustrated in FIG. 9. FIG. 36 is a contour diagram illustrating a simulation result of the viewing angle characteristic of transmittance for the liquid crystal display panel according to Example 9. FIG. 37 is a contour diagram illustrating a simulation result of the viewing angle characteristic of transmittance for the liquid crystal display panel according to Example 10.

The viewing angle characteristic was equivalent between Examples 1, 9, and 10 as illustrated in FIGS. 9, 36, and 37.

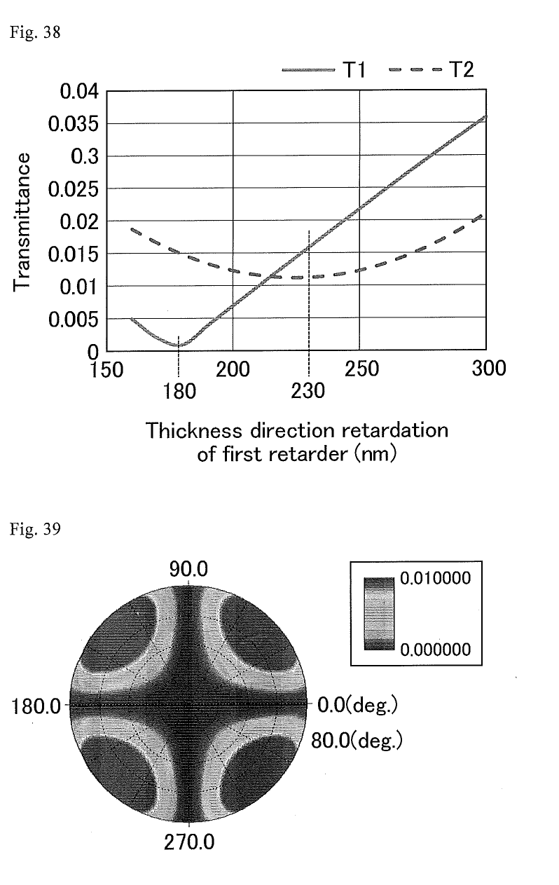

The following describes, with reference to FIG. 38, effects of difference in the thickness direction retardation of the first retarder 7 when the first λ/4 plate 6 and the second λ/4 plate 10 are biaxial λ/4 plates (nx>ny>nz, and Nz=1.5). FIG. 38 is a graph illustrating the relation between the thickness direction retardation of the first retarder and transmittance when the first λ/4 plate and the second λ/4 plate are biaxial λ/4 plates (nx>ny>nz, and Nz=1.5).

In FIG. 38, T1 represents the absolute value of the difference between transmittance when observation is made in a direction at the azimuth angle of 25° and the polar angle of 60° and transmittance when observation is made in a direction at the azimuth angle of 65° and the polar angle of 60°, in the black display state (with no voltage application). T1 decreases as the symmetric property of the viewing angle characteristic with respect to a direction at the azimuth angle of 45° improves. As a result of calculations of T1 with different thickness direction retardations of the first retarder 7, T1 was minimum when the thickness direction retardation was 180 nm (Example 9) as illustrated in FIG. 38. Thus, Example 9 is preferably employed if an improvement in the symmetric property of the viewing angle characteristic is desired when the first λ/4 plate 6 and the second λ/4 plate 10 are biaxial λ/4 plates (nx>ny>nz, and Nz=1.5).

In FIG. 38, T2 represents the average value of transmittance when observation is made in directions at the azimuth angles of 0 to 360° (5° intervals) and the polar angle of 60° in the black display state (with no voltage application). T2 decreases as the transmittance decreases on average irrespective of the azimuth angle (light leakage is low in the black display state). As a result of calculations of T2 with different thickness direction retardations of the first retarder 7, T2 was minimum when the thickness direction retardation was 230 nm (Example 10) as illustrated in FIG. 38. Thus, Example 10 is preferably employed if a small average value of transmittance is desired when the first λ/4 plate 6 and the second λ/4 plate 10 are biaxial λ/4 plates (nx>ny>nz, and Nz=1.5).

As understood from comparison between FIGS. 22 and 38, the optimum value of the thickness direction retardation of the first retarder 7 is higher when the first λ/4 plate 6 and the second λ/4 plate 10 are biaxial λ/4 plates (FIG. 38) than when the first λ/4 plate 6 and the second λ/4 plate 10 are uniaxial λ/4 plates (FIG. 22). This is qualitatively understood as follows. The thickness direction retardations of the first λ/4 plate 6 and the second λ/4 plate 10 are, for example, −68.75 nm for Nz=1.0, and −137.5 nm for Nz=1.5. Thus, as the Nz coefficients of the first λ/4 plate 6 and the second λ/4 plate 10 increase, the thickness direction retardations thereof (in the above-described example, 68.75 nm) decrease, and the thickness direction retardation of the first retarder 7 needs to be increased to compensate the decrease. Specifically, when the first λ/4 plate 6 and the second λ/4 plate 10 are changed from uniaxial λ/4 plates to biaxial λ/4 plates, an effect equivalent to that when the first λ/4 plate 6 and the second λ/4 plate 10 are uniaxial λ/4 plates can be obtained by adjusting the thickness direction retardation of the first retarder 7 with taken into account change in the thickness direction retardations thereof.

Simulation of the liquid crystal display panel according to Embodiment 1-1 was performed representatively with the liquid crystal display panels according to Examples 1 to 10 as described above. The same simulation results as those of the liquid crystal display panel according to Embodiment 1-1 can be obtained for the liquid crystal display panel according to Embodiment 1-2 when the same components are used.

### [Evaluation 8]

Simulation was performed on the viewing angle characteristic of transmittance (the relation between transmittance and each of an azimuth angle and a polar angle) for Examples 12, 13, and 14, Reference Example 1, and Comparative Example 2 by the same evaluation method as that of [Evaluation 1] described above.

### (Evaluation Result)

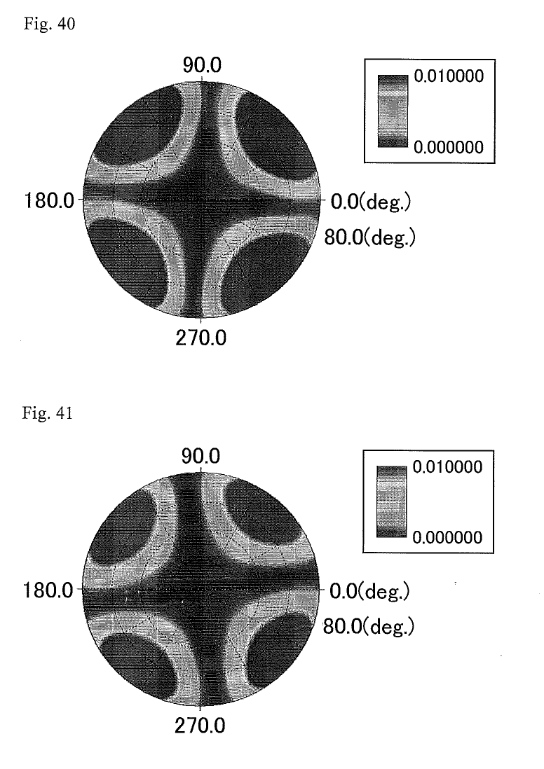

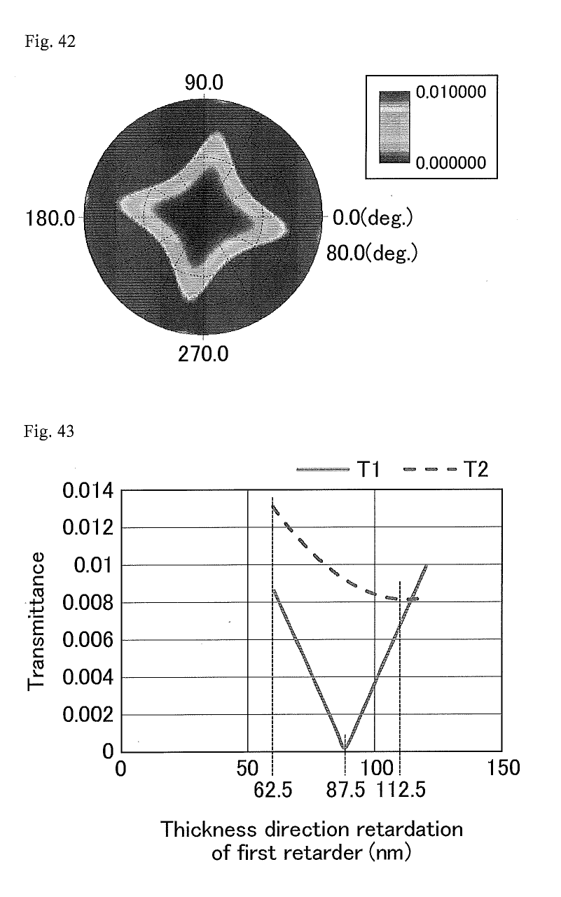

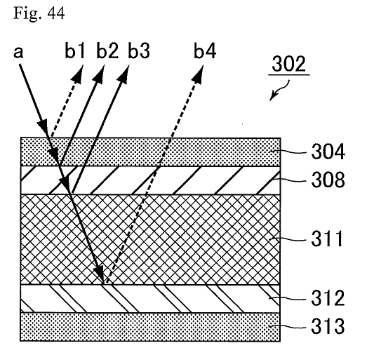

FIG. 39 is a contour diagram illustrating a simulation result of the viewing angle characteristic of transmittance for the liquid crystal display panel according to Example 12. FIG. 40 is a contour diagram illustrating a simulation result of the viewing angle characteristic of transmittance for the liquid crystal display panel according to Example 13. FIG. 41 is a contour diagram illustrating a simulation result of the viewing angle characteristic of transmittance for the liquid crystal display panel according to Example 14. FIG. 11 already illustrates the simulation result of Reference Example 1. FIG. 42 is a contour diagram illustrating a simulation result of the viewing angle characteristic of transmittance for the liquid crystal display panel according to Comparative Example 2.

As illustrated in FIGS. 39 to 41, the viewing angle characteristic was equivalent between Examples 12, 13, and 14. As understood from comparison with FIG. 11, a viewing angle characteristic equivalent to that of Reference Example 1 was obtained for Examples 12, 13, and 14. In other words, according to Examples 12, 13, and 14, similarly to Reference Example 1, an excellent black display state was achieved even when observed in an oblique direction. However, Comparative Example 2 was less excellent in the viewing angle characteristic than Example 12, Example 13, Example 14, and Reference Example 1 as illustrated in FIGS. 11 and 39 to 42, and in particular, exhibited a narrow viewing angle in an oblique direction. This is because, in Comparative Example 2, no retarder (for example, the first retarder 27 of Example 12) for achieving optimization (optical compensation) of change of the polarization state in an oblique direction is disposed between the first λ/4 plate 206 and the second λ/4 plate 210.

The following describes, with reference to FIG. 43, effects of difference in the thickness direction retardation of the first retarder 27 when the first λ/4 plate 26 and the second λ/4 plate 30 are uniaxial λ/4 plates (nx<ny=nz, and Nz=0). FIG. 43 is a graph illustrating the relation between the thickness direction retardation of the first retarder and transmittance when the first λ/4 plate and the second λ/4 plate are uniaxial λ/4 plates (nx<ny=nz, and Nz=0).

In FIG. 43, T1 represents the absolute value of the difference between transmittance when observation is made in a direction at the azimuth angle of 25° and the polar angle of 60° and transmittance when observation is made in a direction at the azimuth angle of 65° and the polar angle of 60°, in the black display state (with no voltage application). T1 decreases as the symmetric property of the viewing angle characteristic with respect to a direction at the azimuth angle of 45° improves. As a result of calculations of T1 with different thickness direction retardations of the first retarder 27, T1 was minimum when the thickness direction retardation was 87.5 nm (Example 12) as illustrated in FIG. 43. Thus, Example 12 is preferably employed if an improvement in the symmetric property of the viewing angle characteristic is desired when the first λ/4 plate 26 and the second λ/4 plate 30 are uniaxial λ/4 plates (nx<ny=nz, and Nz=0).

In FIG. 43, T2 represents the average value of transmittance when observation is made in directions at the azimuth angles of 0 to 360° (50 intervals) and the polar angle of 60° in the black display state (with no voltage application). T2 decreases as the transmittance decreases on average irrespective of the azimuth angle (light leakage is low in the black display state). As a result of calculations of T2 with different thickness direction retardations of the first retarder 27, T2 was minimum when the thickness direction retardation was 112.5 nm (Example 14) as illustrated in FIG. 43. Thus, Example 14 is preferably employed if a small average value of transmittance is desired when the first λ/4 plate 26 and the second λ/4 plate 30 are uniaxial λ/4 plates (nx<ny=nz, and Nz=0).

Accordingly, in the second liquid crystal display panel according to the present invention, the first retarder 27 preferably has a thickness direction retardation of 87.5 nm or more and 112.5 nm or less when the principal refractive indexes of the first λ/4 plate 26 and the second λ/4 plate 30 satisfy the relation of ny=nz, in other words, satisfy the relation of nx<ny=nz (uniaxial λ/4 plate: negative A plate). A preferable range of the thickness direction retardation of the first retarder 27 depends on a designing concept (whether to focus on the symmetric property of the viewing angle characteristic or the average value of transmittance) of the liquid crystal display panel.

Simulation of the liquid crystal display panel according to Embodiment 2-1 was performed representatively with the liquid crystal display panels according to Examples 12 to 14 as described above. When at least one of the first λ/4 plate 26 and the second λ/4 plate 30 is changed from a uniaxial λ/4 plate (nx<ny=nz, and Nz=0) to a biaxial λ/4 plate (nx<ny<nz, Nz<0), an effect equivalent to that when the first λ/4 plate 26 and the second λ/4 plate 30 are uniaxial λ/4 plates can be obtained by adjusting the thickness direction retardation of the first retarder 27 with taken into account change in the thickness direction retardation thereof, similarly to [Evaluation 5], [Evaluation 6], and [Evaluation 7] described above. The same simulation results as those of the liquid crystal display panel according to Embodiment 2-1 can be obtained for the liquid crystal display panel according to Embodiment 2-2 when the same components are used.

### [Additional Remarks]

An aspect of the present invention may be a liquid crystal display panel (the first liquid crystal display panel according to the present invention) including, sequentially from an observation surface side toward a back surface side: a first polarizing plate; a first retardation provision portion; a first substrate; a second retardation provision portion; a liquid crystal layer containing nematic liquid crystal; a second substrate; and a second polarizing plate. One of the first substrate and the second substrate includes a pair of electrodes configured to generate a horizontal electric field at the liquid crystal layer upon voltage application. The nematic liquid crystal homogeneously aligns with no voltage application between the electrodes. The first retardation provision portion includes a first λ/4 plate having principal refractive indexes satisfying the relation of nx>ny≥nz. The second retardation provision portion includes a second λ/4 plate having principal refractive indexes satisfying the relation of nx>ny≥nz. One of the first retardation provision portion and the second retardation provision portion includes, on the first substrate side, a first retarder having principal refractive indexes satisfying the relation of nx≤ny<nz. The in-plane slow axis of the first λ/4 plate forms an angle of 45° with the absorption axis of the first polarizing plate and is orthogonal to the in-plane slow axis of the second λ/4 plate. According to this aspect, an excellent viewing angle characteristic at a bright place is obtained by the following effects.

(1) Since a circular polarizing plate in which the first polarizing plate and the first λ/4 plate are stacked is disposed on the observation surface side in the first liquid crystal display panel according to the present invention, increased visibility at a bright place is achieved by the effect of reflection prevention by the circular polarizing plate.

(2) Since the first retarder is disposed between the first λ/4 plate and the second λ/4 plate, a configuration optically equivalent to that of a conventional horizontal electric field mode liquid crystal display panel can be achieved not only for light incident in a direction normal to the first liquid crystal display panel according to the present invention but also for light incident in a direction oblique thereto.

Another aspect of the present invention may be a liquid crystal display panel (the second liquid crystal display panel according to the present invention) including, sequentially from an observation surface side toward a back surface side: a first polarizing plate; a first retardation provision portion; a first substrate; a second retardation provision portion; a liquid crystal layer containing nematic liquid crystal; a second substrate; and a second polarizing plate. One of the first substrate and the second substrate includes a pair of electrodes configured to generate a horizontal electric field at the liquid crystal layer upon voltage application. The nematic liquid crystal homogeneously aligns with no voltage application between the electrodes. The first retardation provision portion includes a first λ/4 plate having principal refractive indexes satisfying the relation of nx<ny≤nz. The second retardation provision portion includes a second λ/4 plate having principal refractive indexes satisfying the relation of nx<ny≤nz. One of the first retardation provision portion and the second retardation provision portion includes, on the first substrate side, a first retarder having principal refractive indexes satisfying the relation of nx≥ny>nz. The in-plane slow axis of the first λ/4 plate forms an angle of 45° with the absorption axis of the first polarizing plate and is orthogonal to the in-plane slow axis of the second λ/4 plate. According to this aspect, an excellent viewing angle characteristic at a bright place is obtained by the following effects.

(1) Since a circular polarizing plate in which the first polarizing plate and the first λ/4 plate are stacked is disposed on the observation surface side in the second liquid crystal display panel according to the present invention, increased visibility at a bright place is achieved by the effect of reflection prevention by the circular polarizing plate.

(2) Since the first retarder is disposed between the first λ/4 plate and the second λ/4 plate, a configuration optically equivalent to that of a conventional horizontal electric field mode liquid crystal display panel can be achieved not only for light incident in a direction normal to the second liquid crystal display panel according to the present invention, but also for light incident in a direction oblique thereto.

In each of the first liquid crystal display panel according to the present invention and the second liquid crystal display panel according to the present invention, the first retardation provision portion may include the first λ/4 plate and the first retarder sequentially from the first polarizing plate side toward the first substrate side. With this configuration, the present invention is also applicable when the first retarder is disposed on a side of the first substrate opposite to the liquid crystal layer.

In each of the first liquid crystal display panel according to the present invention and the second liquid crystal display panel according to the present invention, the second retardation provision portion may include the second λ/4 plate and the first retarder sequentially from the liquid crystal layer side toward the first substrate side. With this configuration, the present invention is also applicable when the first retarder is disposed on the liquid crystal layer side of the first substrate.

In the first liquid crystal display panel according to the present invention, the first retardation provision portion may include a second retarder satisfying the relation of nx<ny=nz, the first λ/4 plate, and the first retarder sequentially from the first polarizing plate side toward the first substrate side. With this configuration, viewing angle correction is performed on the first polarizing plate and the second polarizing plate by the second retarder, thereby obtaining a wider viewing angle.

In each of the first liquid crystal display panel according to the present invention and the second liquid crystal display panel according to the present invention, the first retarder may have a thickness direction retardation of 87.5 nm or more and 112.5 nm or less when the principal refractive indexes of the first λ/4 plate and the second λ/4 plate satisfy the relation of ny=nz. With this configuration, excellent balance can be achieved between the symmetric property of the viewing angle characteristic and the average value of transmittance.

In each of the first liquid crystal display panel according to the present invention and the second liquid crystal display panel according to the present invention, the nematic liquid crystal may have an alignment direction parallel to the absorption axis of the second polarizing plate with no voltage application between the electrodes. With this configuration, an excellent coloring state can be achieved (the black display quality can be increased).

Another aspect of the present invention may be a liquid crystal display device including the liquid crystal display panel (the first liquid crystal display panel according to the present invention or the second liquid crystal display panel according to the present invention). According to this aspect, a liquid crystal display device having an excellent viewing angle characteristic at a bright place can be achieved.

### REFERENCE SIGNS LIST

1a, 1b, 1c, 21a, 21b: liquid crystal display device
2a, 2b, 2c, 22a, 22b, 102, 202, 302: liquid crystal display panel
3: backlight
4, 104, 204, 304: first polarizing plate
5a, 5b, 5c, 25a, 25b: first retardation provision portion
6, 26, 206: first λ/4 plate
7, 27: first retarder
8, 108, 208, 308: first substrate
9a, 9b, 29a, 29b: second retardation provision portion
10, 30, 210: second λ/4 plate
11, 111, 211, 311: liquid crystal layer
12, 112, 212, 312: second substrate
13, 113, 213, 313: second polarizing plate
14: support substrate
15: common electrode (planar electrode)
16: insulating film
17: pixel electrode (comb teeth electrode)
18: second retarder
a: incident light
b1, b2, b3, b4: reflected light

1. A liquid crystal display panel comprising, sequentially from an observation surface side toward a back surface side,
a first polarizing plate;
a first retardation provision portion;
a first substrate;
a second retardation provision portion;
a liquid crystal layer containing nematic liquid crystal;
a second substrate; and
a second polarizing plate,
wherein one of the first substrate and the second substrate includes a pair of electrodes configured to generate a horizontal electric field at the liquid crystal layer upon voltage application,
the nematic liquid crystal homogeneously aligns with no voltage application between the electrodes,
the first retardation provision portion includes a first λ/4 plate having principal refractive indexes satisfying the relation of nx>ny≥nz,
the second retardation provision portion includes a second λ/4 plate having principal refractive indexes satisfying the relation of nx>ny≥nz,
one of the first retardation provision portion and the second retardation provision portion includes, on the first substrate side, a first retarder having principal refractive indexes satisfying the relation of nx≤ny<nz, and
the in-plane slow axis of the first λ/4 plate forms an angle of 45° with the absorption axis of the first polarizing plate and is orthogonal to the in-plane slow axis of the second λ/4 plate.

2. A liquid crystal display panel comprising, sequentially from an observation surface side toward a back surface side,
a first polarizing plate;
a first retardation provision portion;
a first substrate;
a second retardation provision portion;
a liquid crystal layer containing nematic liquid crystal;
a second substrate; and
a second polarizing plate,
wherein one of the first substrate and the second substrate includes a pair of electrodes configured to generate a horizontal electric field at the liquid crystal layer upon voltage application,
the nematic liquid crystal homogeneously aligns with no voltage application between the electrodes,
the first retardation provision portion includes a first λ/4 plate having principal refractive indexes satisfying the relation of nx<ny≤nz,
the second retardation provision portion includes a second λ/4 plate having principal refractive indexes satisfying the relation of nx<ny≤nz,
one of the first retardation provision portion and the second retardation provision portion includes, on the first substrate side, a first retarder having principal refractive indexes satisfying the relation of nx≥ny>nz, and
the in-plane slow axis of the first λ/4 plate forms an angle of 45° with the absorption axis of the first polarizing plate and is orthogonal to the in-plane slow axis of the second λ/4 plate.

3. The liquid crystal display panel according to claim 1, wherein the first retardation provision portion includes the first λ/4 plate and the first retarder sequentially from the first polarizing plate side toward the first substrate side.

4. The liquid crystal display panel according to claim 1,
wherein the second retardation provision portion includes the second λ/4 plate and the first retarder sequentially from the liquid crystal layer side toward the first substrate side.

5. The liquid crystal display panel according to claim 1,
wherein the first retardation provision portion includes a second retarder satisfying the relation of nx<ny=nz, the first λ/4 plate, and the first retarder sequentially from the first polarizing plate side toward the first substrate side.

6. The liquid crystal display panel according to claim 1,
wherein the first retarder has a thickness direction retardation of 87.5 nm or more and 112.5 nm or less when the principal refractive indexes of the first λ/4 plate and the second λ/4 plate satisfy the relation of ny=nz.

7. The liquid crystal display panel according to claim 1,
wherein the nematic liquid crystal has an alignment direction parallel to the absorption axis of the second polarizing plate with no voltage application between the electrodes.

8. A liquid crystal display device comprising the liquid crystal display panel according to claim 1.

9. The liquid crystal display panel according to claim 2, wherein the first retardation provision portion includes the first λ/4 plate and the first retarder sequentially from the first polarizing plate side toward the first substrate side.

10. The liquid crystal display panel according to claim 2,
wherein the second retardation provision portion includes the second λ/4 plate and the first retarder sequentially from the liquid crystal layer side toward the first substrate side.

11. The liquid crystal display panel according to claim 2,
wherein the first retarder has a thickness direction retardation of 87.5 nm or more and 112.5 nm or less when the principal refractive indexes of the first λ/4 plate and the second λ/4 plate satisfy the relation of ny=nz.

12. The liquid crystal display panel according to claim 2,
wherein the nematic liquid crystal has an alignment direction parallel to the absorption axis of the second polarizing plate with no voltage application between the electrodes.

13. A liquid crystal display device comprising the liquid crystal display panel according to claim 2.
